(19) United States
(12) Patent Application Publication
(10) Pub. No.: US 2025/0227694 A1
(43) Pub. Date: Jul. 10, 2025

(54) SIMULTANEOUS MULTI-PANEL AND TRP TRANSMISSION

(71) Applicant: Intel Corporation, Santa Clara, CA (US)

(72) Inventors: Dong Han, San Jose, CA (US); Bishwarup Mondal, San Ramon, CA (US); Gang Xiong, Beaverton, OR (US); Avik Sengupta, San Jose, CA (US); Guotong Wang, Beijing (CN)

(21) Appl. No.: 18/852,699

(22) PCT Filed: Jul. 6, 2023
(86) PCT No.: PCT/US2023/027027

§ 371 Date: Sep. 30, 2024

Related U.S. Application Data
(60) Provisional application No. 63/390,526, filed on Jul. 19, 2022.
(60) Provisional application No. 63/396,362, filed on Aug. 9, 2022.
(60) Provisional application No. 63/410,111, filed on Sep. 26, 2022.

(51) Int. Cl. H04W 72/1268; H04B 7/06; H04L 5/00; H04W 72/0446; H04W 72/0453; H04W 72/231

(52) U.S. Cl. CPC H04W 72/1268; H04B 7/0626; H04L 5/0051; H04W 72/0446; H04W 72/0453; H04W 72/231

(57) ABSTRACT

An apparatus and system of supporting simultaneous transmission over multi-panel (STxMP) uplink (UL) transmissions are described. At least one downlink control information (DCI) is used to schedule STxMP UL transmission to multiple transmit-receive points (TRPs). The DCI indicates whether time domain (TD) repetition is to be applied, in addition to time domain and/or frequency domain resource location for different multiplexing schemes. Aperiodic-channel state information (A-CSI) or semi-persistent CSI (SP-CSI) multiplexing is multiplexed within one or more of the repetitions. One or more sounding reference signal (SRS) resource indication (SRI) fields in the DCI indicate the SRS resources to use for the transmission. Mechanisms of physical uplink control channel (PUCCH) resource configuration are described for STxMP operation.

### PRIORITY CLAIM

This application claims the benefit of priority to U.S. Provisional Patent Application Ser. No. 63/390,526, filed Jul. 19, 2022, Provisional Patent Application Ser. No. 63/396,362, filed Aug. 9, 2022, and Provisional Patent Application Ser. No. 63/410,111, filed Sep. 26, 2022, each of which is incorporated herein by reference in its entirety.

### TECHNICAL FIELD

Embodiments pertain to communications in 3GPP networks. In particular, some embodiments relate to simultaneous multi-panel and transmit-receive point (TRP) transmissions and configurations thereof in fifth generation (5G) and later networks.

### BACKGROUND

The use and complexity of wireless systems has increased due to both an increase in the types of electronic devices using network resources as well as the amount of data and bandwidth being used by various applications, such as video streaming, operating on the electronic devices. As expected, a number of issues abound with the advent of any new technology, including complexities related to the use of multiple TRPs and multiple panels.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some embodiments.

FIG. 3 illustrates simultaneous multi-TRP multi-panel transmission in accordance with some embodiments.

FIGS. 4A and 4B illustrate simultaneous transmission with multi-panel (STxMP) with time domain (TD) repetition respectively without and with panel switching in accordance with some embodiments.

FIGS. 5A and 5B respectively illustrate consecutive and interleaved resource allocation for a Physical Uplink Shared Channel (PUSCH) in panel 1 and 2 in accordance with some embodiments.

FIG. 6A illustrates single downlink control information (DCI) based frequency domain multiplexing (FDM) STxMP with TD repetition with frequency/panel switching in accordance with some embodiments.

FIG. 6B illustrates single DCI based FDM STxMP with TD repetition without frequency/panel switching in accordance with some embodiments.

FIGS. 7A and 7B respectively illustrate multi-DCI based FDM STxMP with TD repetition with and without frequency/panel switching in accordance with some embodiments.

FIGS. 8A and 8B respectively illustrate multi-DCI based FDM STxMP with TD repetition with or without frequency/panel switching in accordance with some embodiments.

FIGS. 9A and 9B respectively illustrate single-DCI based SDM STxMP with TD repetition with or without frequency/panel switching in accordance with some embodiments.

FIGS. 10A and 10B respectively illustrate multi-DCI based SDM STxMP with TD repetition with or without frequency/panel switching in accordance with some embodiments.

FIGS. 11A and 11B respectively illustrate multi-DCI based SDM STxMP with TD repetition with or without frequency/panel switching in accordance with some embodiments.

FIGS. 12A and 12B respectively illustrate an aperiodic-channel state information (A-CSI) or semi-persistent CSI (SP-CSI) multiplexing on a STxMP PUSCH transmission or STxMP PUSCH repetitions in accordance with some embodiments.

FIGS. 13A and 13B respectively illustrate an A-CSI or SP-CSI multiplexing on a first TD repetition or on first and second repetitions of a STxMP PUSCH transmission in accordance with some embodiments.

FIG. 14 illustrates physical resource block (PRB) distance for a Physical Uplink Control Channel (PUCCH) transmission from a first and second panel transmission in accordance with some embodiments.

FIG. 15 illustrates a panel ID in accordance with some embodiments.

FIG. 16 illustrates another panel ID in accordance with some embodiments.

FIG. 17 illustrates another panel ID in accordance with some embodiments.

FIG. 18 illustrates a frequency resource for PUCCH for a first and second panel for STxMP operation in accordance with some embodiments.

FIG. 19 illustrates separate discrete Fourier transform (DFT) operations for modulated symbols for a STxMP PUCCH FDM-A scheme in accordance with some embodiments.

FIG. 20 illustrates a single DFT operation for modulated symbols for a STxMP PUCCH FDM-A scheme in accordance with some embodiments.

FIG. 21 illustrates a flowchart of codebook (CB) and non-codebook (nCB) based multi-TRP transmissions in accordance with some embodiments.

FIG. 22 illustrates a flowchart of PUCCH transmission in accordance with some embodiments.

FIG. 23 illustrates another flowchart of PUCCH transmission in accordance with some embodiments.

FIG. 24 illustrates a flowchart of PUSCH transmission in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

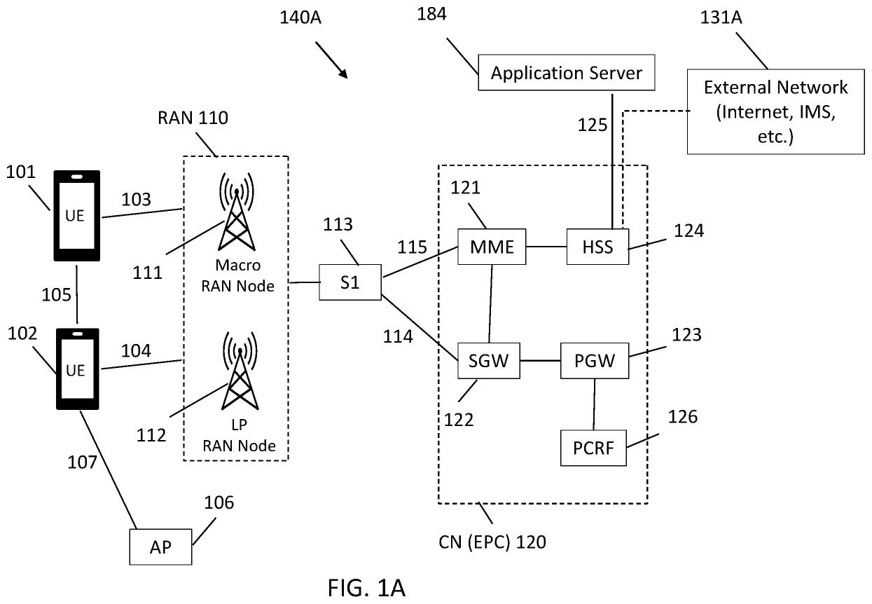

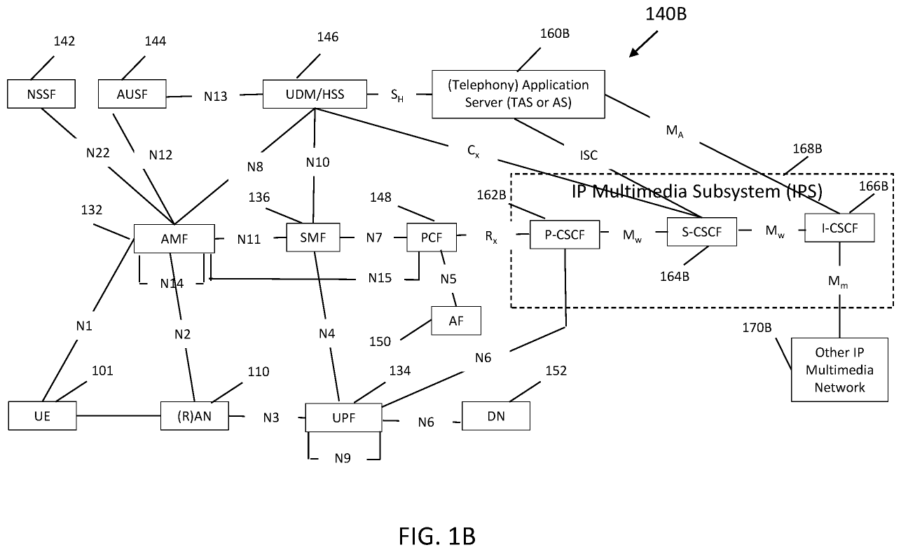

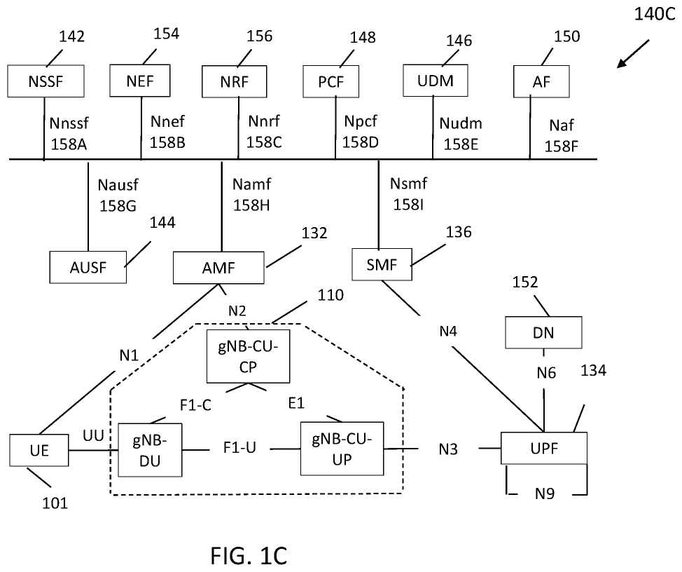

FIG. 1A illustrates an architecture of a network in accordance with some aspects. The network 140A includes 3GPP LTE/4G and NG network functions that may be extended to 6G and later generation functions. Accordingly, although 5G is referred to herein, it is to be understood that this is to extend as able to 6G (and later) structures, systems, and functions. A network function can be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHZ, and other frequencies and Spectrum Access System (SAS) in 3.55-3.7 GHz and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN. The RAN 110 may contain one or more gNBs, one or more of which may be implemented by multiple units. Note that although gNBs may be referred to herein, the same aspects may apply to other generation NodeBs, such as 6^{th} generation NodeBs—and thus may be alternately referred to as next generation NodeB (xNB).

Each of the gNBs may implement protocol entities in the 3GPP protocol stack, in which the layers are considered to be ordered, from lowest to highest, in the order Physical (PHY), Medium Access Control (MAC), Radio Link Control (RLC), Packet Data Convergence Control (PDCP), and Radio Resource Control (RRC)/Service Data Adaptation Protocol (SDAP) (for the control plane/user plane). The protocol layers in each gNB may be distributed in different units—a Central Unit (CU), at least one Distributed Unit (DU), and a Remote Radio Head (RRH). The CU may provide functionalities such as the control the transfer of user data, and effect mobility control, radio access network sharing, positioning, and session management, except those functions allocated exclusively to the DU.

The higher protocol layers (PDCP and RRC for the control plane/PDCP and SDAP for the user plane) may be implemented in the CU, and the RLC and MAC layers may be implemented in the DU. The PHY layer may be split, with the higher PHY layer also implemented in the DU, while the lower PHY layer is implemented in the RRH. The CU, DU and RRH may be implemented by different manufacturers, but may nevertheless be connected by the appropriate interfaces therebetween. The CU may be connected with multiple DUs.

The interfaces within the gNB include the E1 and front-haul (F) F1 interface. The E1 interface may be between a CU control plane (gNB-CU-CP) and the CU user plane (gNB-CU-UP) and thus may support the exchange of signaling information between the control plane and the user plane through E1AP service. The E1 interface may separate Radio Network Layer and Transport Network Layer and enable exchange of UE associated information and non-UE associated information. The E1AP services may be non UE-associated services that are related to the entire E1 interface instance between the gNB-CU-CP and gNB-CU-UP using a non UE-associated signaling connection and UE-associated services that are related to a single UE and are associated with a UE-associated signaling connection that is maintained for the UE.

The F1 interface may be disposed between the CU and the DU. The CU may control the operation of the DU over the F1 interface. As the signaling in the gNB is split into control plane and user plane signaling, the F1 interface may be split into the F1-C interface for control plane signaling between the gNB-DU and the gNB-CU-CP, and the F1-U interface for user plane signaling between the gNB-DU and the gNB-CU-UP, which support control plane and user plane separation. The F1 interface may separate the Radio Network and Transport Network Layers and enable exchange of UE associated information and non-UE associated information. In addition, an F2 interface may be between the lower and upper parts of the NR PHY layer. The F2 interface may also be separated into F2-C and F2-U interfaces based on control plane and user plane functionalities.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 can be transmission-reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and can be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 can be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A can be an IoT network or a 5G or 6G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a core network (CN) 120. The NG-RAN 110 can include a plurality of nodes, such as gNBs and NG-eNBs. The CN 120 (e.g., a 5G core network (5GC)) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces, and to the UPF by NG-U interfaces. The gNBs and the NG-eNBs can be coupled to each other via Xn interfaces.

In some aspects, the NG system architecture can use reference points between various nodes. In some aspects, each of the gNBs and the NG-eNBs can be implemented as a base station, a mobile edge server, a small cell, a home eNB, and so forth. In some aspects, a gNB can be a master node (MN) and NG-eNB can be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 can be in communication with RAN 110 as well as one or more other CN network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 can be used to manage access control and mobility and can also include network slice selection functionality. The AMF 132 may provide UE-based authentication, authorization, mobility management, etc., and may be independent of the access technologies. The SMF 136 can be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 can be deployed in one or more configurations according to the desired service type and may be connected with a data network. The PCF 148 can be configured to provide a policy framework using network slicing, mobility management, and roaming (similar to PCRF in a 4G communication system). The UDM can be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain aspects of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some aspects, the I-CSCF 166B can be connected to another IP multimedia network 170B, e.g. an IMS operated by a different network operator.

In some aspects, the UDM/HSS 146 can be coupled to an application server (AS) 160B, which can include a telephony application server (TAS) or another application server. The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures can be service-based and interaction between network functions can be represented by corresponding point-to-point reference points Ni or as service-based interfaces.

In some aspects, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein can be used for supporting high reliability in distributed communication systems with dynamic topologies, including sidelink NR V2X communication systems.

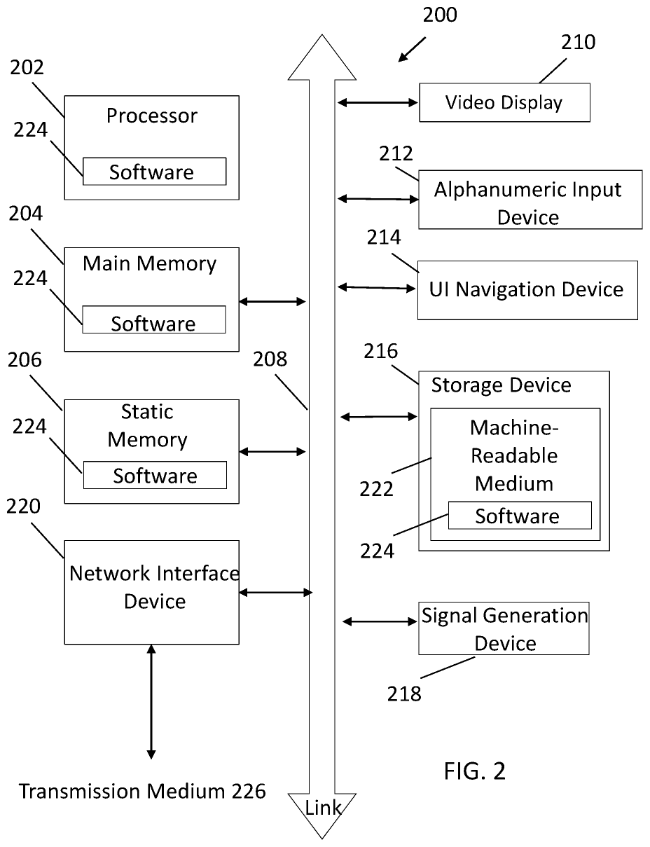

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or other sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5^{th} generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth®, Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (12V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety re-lated applications in the frequency range 5,875 GHz to 5,905 GHz), ITS-G5B (i.e., Operation in European ITS frequency bands dedicated to ITS non-safety applications in the frequency range 5,855 GHz to 5,875 GHZ), ITS-G5C (i.e., Operation of ITS applications in the frequency range 5,470 GHz to 5,725 GHZ)), DSRC in Japan in the 700 MHz band (including 715 MHz to 725 MHz), IEEE 802.11bd based systems, etc.

Aspects described herein can be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHZ, 3.6-3.8 GHz and further frequencies and SAS=Spectrum Access System/CBRS=Citizen Broadband Radio System in 3.55-3.7 GHZ and further frequencies). Applicable spectrum bands include IMT (International Mobile Telecommunications) spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHZ, 1710-2025 MHz, 2110-2200 MHz, 2300-2400 MHZ, 2.4-2.4835 GHz (note: it is an ISM band with global availability and it is used by Wi-Fi technology family (11b/g/n/ax) and also by Bluetooth), 2500-2690 MHz, 698-790 MHZ, 610-790 MHz, 3400-3600 MHZ, 3400-3800 MHZ, 3800-4200 MHz, 3.55-3.7 GHZ (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively. Next generation Wi-Fi system is expected to include the 6 GHz spectrum as operating band but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHZ, 3800-4200 MHZ, 3.5 GHz bands, 700 MHz bands, bands within the 24.25-86 GHz range, etc.), spectrum made available under FCC's “Spectrum Frontier” 5G initiative (including 27.5-28.35 GHZ, 29.1-29.25 GHZ, 31-31.3 GHZ, 37-38.6 GHZ, 38.6-40 GHz, 42-42.5 GHZ, 57-64 GHz, 71-76 GHZ, 81-86 GHz and 92-94 GHz, etc), the ITS (Intelligent Transport Systems) band of 5.9 GHz (typically 5.85-5.925 GHz) and 63-64 GHz, bands currently allocated to WiGig such as WiGig Band 1 (57.24-59.40 GHZ), WiGig Band 2 (59.40-61.56 GHz) and WiGig Band 3 (61.56-63.72 GHZ) and WiGig Band 4 (63.72-65.88 GHZ), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHZ, and future bands including 94-300 GHz and above. Furthermore, the scheme can be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

Aspects described herein can also implement a hierarchical application of the scheme is possible, e.g., by introducing a hierarchical prioritization of usage for different types of users (e.g., low/medium/high priority, etc.), based on a prioritized access to the spectrum e.g., with highest priority to tier-1 users, followed by tier-2, then tier-3, etc. users, etc.

Aspects described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

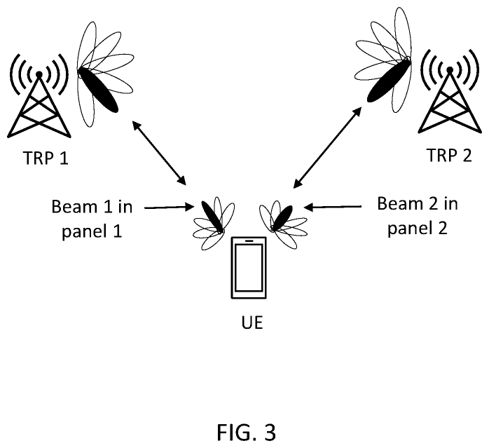

As above, Rel-17 NR supports multi-TRP physical uplink shared channel (PUSCH) repetitions and physical uplink control channel (PUCCH) repetitions. This allows the same uplink (UL) data or control information to be transmitted to multiple TRPs as multiple repetitions/transmissions in multiple time slots or sub-slots. However, in each time slot or sub-slot, only one UL transmission occasion occurs towards a certain TRP. To utilize the multiple TRPs more efficiently, it is desirable for the Rel-18 5G NR system to support simultaneous multi-TRP multi-panel transmission schemes in UL, where the UE is equipped with multiple antenna panels. FIG. 3 illustrates simultaneous multi-TRP multi-panel transmission in accordance with some embodiments. In particular, to increase the overall capacity and to increase robustness of the transmission to potential blockage of the channel, the UE may transmit data and control information targeting two or more TRPs simultaneously as shown in FIG. 3. In FIG. 3, the transmit beam from panel 1 is targets TRP1, and the transmit beam from panel 2 targets TRP 2.

To support simultaneous multi-TRP (mTRP) multi-panel transmission operations in UL, different transmission schemes can be considered. For example, the mTRP transmissions can be scheduled by either a single DCI (sDCI) or multiple DCIs (mDCI). In particular, a single-downlink control information (DCI)-based scheme schedules PUSCH transmissions by a single DCI that is either transmitted through one TRP or multiple TRPs. A multi-DCI-based scheme schedules the PUSCH transmissions by multiple DCIs through multiple TRPs.

In Rel-17, multi-TRP based repetition schemes were supported, where the same transport block (TB) and uplink control information (UCI) may be transmitted with different PUSCH/PUCCH repetitions to different TRPs in a time domain multiplexing (TDM) manner to increase the reliability of the communication. In Rel-18, simultaneous transmission with multi-panel (STxMP) is supported, where two PUSCH/PUCCH transmission occasions may be transmitted from two different UE panels to two different TRPs simultaneously.

Different multiplexing types in STxMP schemes may be used, such as spatial domain multiplexing (SDM), frequency domain multiplexing (FDM), single frequency network (SFN). For example, in SDM STxMP, the same or different layers of one PUSCH or two PUSCHs (with the same or different TB) may be simultaneously transmitted separately from different UE panels. In FDM-A STxMP, different parts of the frequency domain resource of one PUSCH transmission occasion may be transmitted from different UE panels. In FDM-B STxMP, two PUSCH transmission occasions with the same or different repetition values (RV) of the same TB may be transmitted from different UE panels on non-overlapped frequency domain resources and the same time domain resources. To enhance the reliability and coverage of the UL transmission, STxMP with repetitions may be allowed in the time domain.

Note that channel state information (CSI) may include a Channel Quality Indicator (CQI), a precoding matrix indicator (PMI), a CSI-RS resource indicator (CRI), a synchronization signal/Physical Broadcast Channel (SS/PBCH) Block Resource indicator (SSBRI), layer indicator (LI), rank indicator (RI), layer 1 Reference Signal Received Power (L1-RSRP) or layer 1 Signal to Interference and Noise Ratio (L1-SINR), which are reported from the UE to the base station. Aperiodic CSI (A-CSI) reporting and semi-persistent CSI (SP-CSI) reporting may be triggered by the CSI request field in the DCI. In this case, the A/SP-CSI reporting and UL transmission may be scheduled by one or more DCIs at the same time. However, how to handle the A/SP-CSI multiplexing on a STxMP transmission is not yet specified.

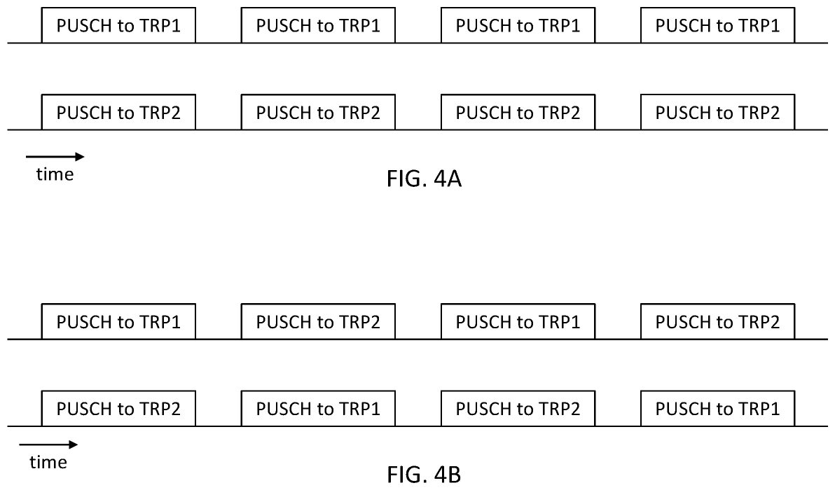

As mentioned above, multi-TRP time domain (TD) repetition may be also supported in STxMP transmission with and without panel switching to enhance the coverage and reliability. FIGS. 4A and 4B illustrate simultaneous transmission with multi-panel (STxMP) with time domain (TD) repetition respectively without and with panel switching in accordance with some embodiments. Note that the TD repetition can be either repetition type-A, which is slot-based, or repetition type-B, which is based on back-to-back repetition. For UL transmissions from UE panel 1 and panel 2, the same frequency resource or a different frequency resource may be used, which corresponds to SDM or FDM-based STxMP schemes, respectively.

In one option, similar to PUSCH repetition for multiple TRP operation, association between the PUSCH in different panels and the Sounding Reference Signal (SRS) resource set may be switched. In particular, in one mode, PUSCH transmission in a first panel may be associated with the first SRS resource set, while the PUSCH in a second panel may be associated with the second SRS resource set.

In another mode, PUSCH transmission in a first panel may be associated with the second SRS resource set, while the PUSCH in a second panel may be associated with the first SRS resource set. Note that switching between the above two modes may be indicated by an existing field, e.g., an SRS resource set indication in the DCI.

In one option, one field in the DCI for scheduling a PUSCH for STxMP may be used to indicate whether panel switching is enabled or disabled when time domain repetition is applied. Alternatively, one reserved state in the existing fields may be used to indicate whether panel switching is enabled or disabled when time domain repetition is applied.

Moreover, the redundancy version for repetitions may be specified for a PUSCH STxMP with and without TD repetition. In one embodiment, for a single-DCI-based PUSCH STxMP without TD repetition, if the two panels are transmitting two repetitions of the same TB, the DCI may indicate the first RV for the first repetition transmitted through the first panel, and the RV pattern (0 2 3 1) is applied cyclically. For example, if the DCI indicates RV0/RV2/RV3/RV1 for the first repetition, the second repetition transmitted through the second panel uses RV2/RV3/RV1/RV0, respectively.

In another embodiment, for a single-DCI based PUSCH STxMP with TD repetition, if the two panels are transmitting the repetitions of two different TBs, i.e., panel-1 transmits the repetitions of TB1 in different time domain resources and panel-2 transmits the repetitions of TB2 in different time domain resources, the DCI may indicate the first RV for the first repetition transmitted through panel-1, and the RV pattern (0 2 3 1) is applied separately to the PUSCH through the two panels with a possibility of configuring RV offset for the starting RV for the first repetition through the second panel. For example, if the DCI indicates RV0/RV2/RV3/RV1 for the first repetition through the first panel and RV offset 1, the first repetition through the second panel uses RV2/RV3/RV1/RV0, respectively. And the following repetitions through the panel use the following RV in RV pattern (0 2 3 1) sequentially.

In another embodiment, for a single-DCI based PUSCH STxMP with TD repetition, if the two panels are transmitting the repetitions of the same TBs, i.e., panel-1 and panel-2 transmit the information of the TB, the DCI may indicate the first RV for the first repetition transmitted through panel-1, and the RV pattern (0 2 3 1) is applied separately to the PUSCH through the two panels with a possibility of configuring RV offset for the starting RV for the first repetition through the second panel. For example, if the DCI indicates RV0/RV2/RV3/RV1 for the first repetition through the first panel and RV offset 1, the first repetition through the second panel uses RV2/RV3/RV1/RV0, respectively. And the following repetitions through the panel use the following RV in RV pattern (0 2 3 1) sequentially.

In another option of the last two embodiments, the RV offset indication may be absent in the DCI, and the RV offset is 1 by default. Note that the repetition mentioned above for RV mapping is the actual repetition for repetition Type B.

The STxMP with TD repetition may be scheduled by a single DCI or multiple DCIs. In the following, different STxMP transmission schemes with TD repetition are described.

FDM STxMP Transmission with TD Repetition

In FDM STxMP transmission, two orthogonal frequency resources in an uplink BWP, are allocated for the UL transmission through panel 1 and panel 2, respectively.

In one embodiment, the two disjoint frequency resources for the PUSCH transmission in a first and second panel may be consecutive in the frequency domain. In one option, the frequency resource for the uplink transmission in the first and second panel may be allocated in a set of consecutive physical resource block (PRBs). In this case, the frequency domain resource allocation (FDRA) field in the DCI for scheduling the PUSCH transmission may be used to indicate the frequency resource allocation of the PUSCH transmission in the first panel. Further, a frequency offset between the starting PRB of the PUSCH transmission in the first and second panel may be configured by higher layers via the NR remaining minimum system information (RMSI), the NR other system information (OSI), or dedicated radio resource control (RRC) signaling, dynamically indicated in the DCI, or a combination thereof.

In another option, the frequency offset between the starting PRB of the PUSCH transmission in the first and second panel may be determined in accordance with the frequency offset that is configured for intra-slot, inter-repetition or inter-slot frequency hopping of the PUSCH transmission.

As a further extension, the frequency offset between the starting PRB of the PUSCH transmission in the first and second panel may be determined in accordance with the bandwidth of the UL bandwidth part (BWP). For instance, the frequency offset may be equal to └N_{BWP}^{size}/2┘, └N_{BWP}^{size}/4┘, or −└N_{BWP}^{size}/4┘. Note that this embodiment may be applicable for uplink resource allocation type 0 and 1.

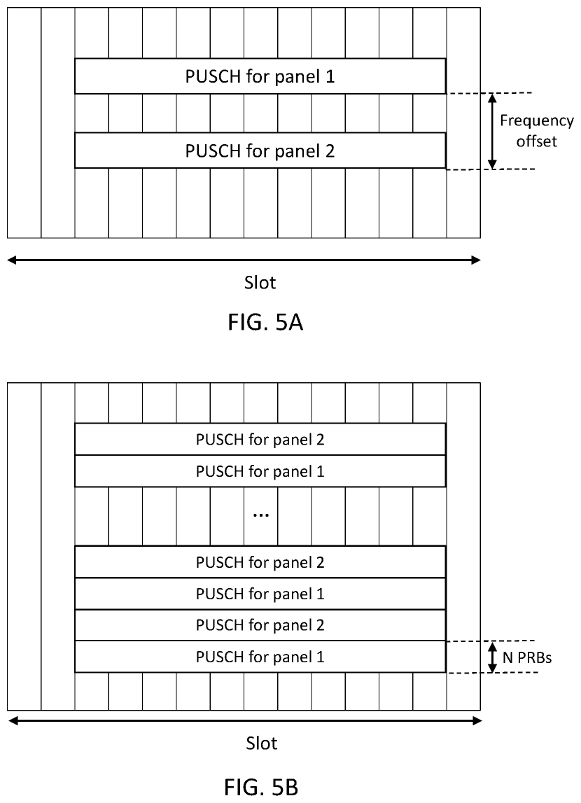

FIGS. 5A and 5B illustrates consecutive resource allocation for a PUSCH in panel 1 and 2 in accordance with some embodiments. In the example shown in FIG. 5A, the frequency offset between the starting PRB for the PUSCH in the panel 1 and 2 may be configured by higher layers.

In another embodiment, the two disjoint frequency resources for the PUSCH transmission for the first and second panel may be interleaved in the frequency domain. In one option, the frequency resource for the PUSCH transmission for the first panel may be allocated with every even N PRBs, while the frequency resource for the PUSCH transmission for the second panel may be allocated with every odd N PRBs, or vice versa. Note that N may be pre-defined in the specification or configured by higher layers via RMSI, OSI, or RRC signaling or dynamically indicated in the DCI or a combination thereof. In another option, N may be determined in accordance with Resource Block Group (RBG) size when uplink resource allocation type 0 is used for frequency resource allocation.

In another option, when uplink resource allocation type 0 is used for frequency resource allocation for the STxMP, the FDRA field in the DCI for scheduling the PUSCH may be used to indicate the frequency resource of the PUSCH transmission for the first panel. Further, the frequency resource of the PUSCH transmission in the second panel may be derived accordingly. For instance, the frequency resource of the PUSCH transmission in the second panel may be shifted by N PRBs from the frequency resource of the PUSCH transmission in the first panel.

In another option, when uplink resource allocation type 0 or type 1 is used for frequency resource allocation for the STxMP, the FDRA field in the DCI for scheduling the PUSCH may be used to indicate the frequency resource of the PUSCH transmission for the first and second panel jointly. Further, the frequency resource of the PUSCH transmission in the first panel may be determined accordingly based on the rule as mentioned above. This may also apply for the determination of frequency resource for the PUSCH transmission in the second panel.

FIG. 5B illustrates interleaved resource allocation for a PUSCH in panel 1 and 2 in accordance with some embodiments. In the example, the PUSCH for panel 1 is transmitted in every even N PRBs, while the PUSCH for panel 2 is transmitted in every odd N PRBs. Note that N may be configured by higher layers as mentioned above.

In FDM STxMP TD repetitions, the association of the two frequency resources with the panels may be switched or not switched in each next STxMP transmission occasion, and the scheduling may be single-DCI or multi-DCI, which are illustrated by the following embodiments.

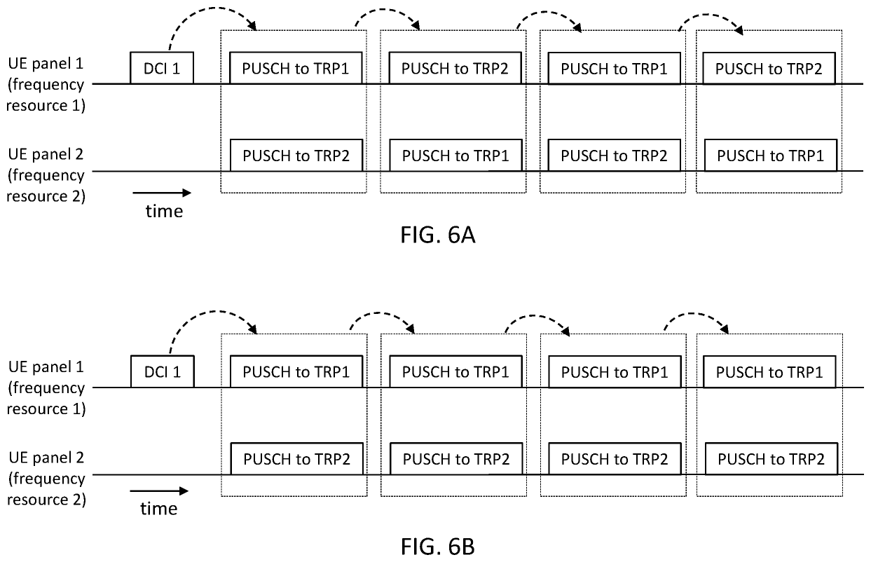

FIGS. 6A and 6B respectively illustrate single DCI based FDM STxMP with TD repetition with and without frequency/panel switching in accordance with some embodiments. The single DCI at least indicates the number of TD repetitions. In particular, a time domain resource allocation field may be used to indicate the one row from a table for the time domain resource allocation of the PUSCH transmission, which includes number of repetitions, mapping type and starting and length indicator value (SLIV). In these and later figures the solid arrows indicate the mTRP repetition process, the dotted arrows indicate the sTRP repetition process, and the box around the PUSCHs indicates one STxMP PUSCH transmission or TD repetition.

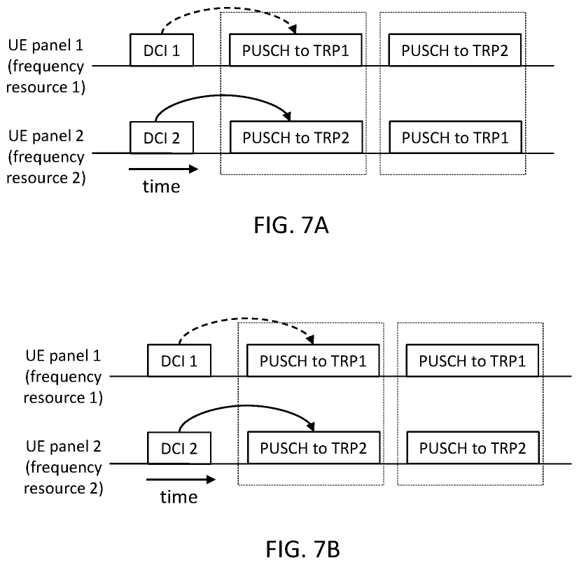

In other embodiments, multiple DCIs may be used to schedule the FDM STxMP with TD repetition. FIGS. 7A and 7B respectively illustrate multi-DCI based FDM STxMP with TD repetition with and without frequency/panel switching in accordance with some embodiments.

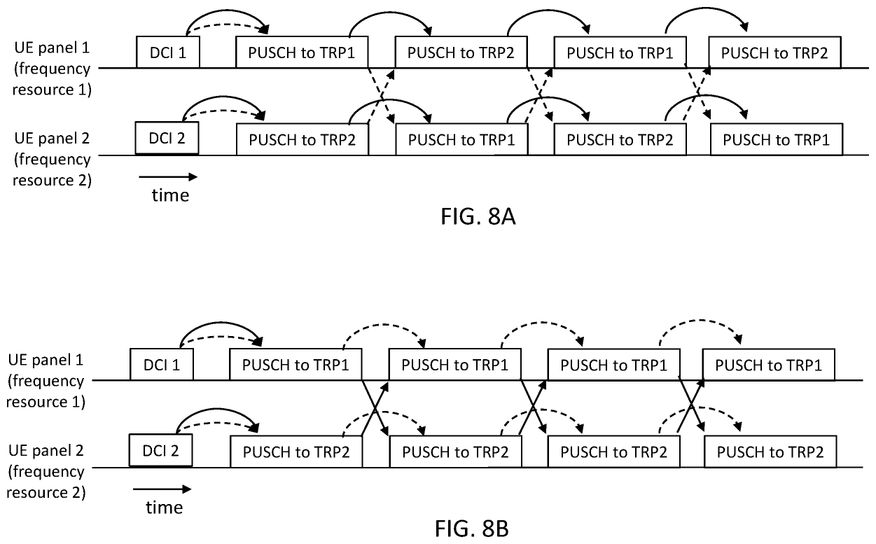

In another embodiment, multi-DCI based FDM STxMP with TD repetition with or without frequency/panel switching may be achieved by other methods. FIGS. 8A and 8B respectively illustrate multi-DCI based FDM STxMP with TD repetition with or without frequency/panel switching in accordance with some embodiments.

In particular, repetition with frequency/panel switching may also be achieved by two simultaneous single-TRP repetition processes with frequency hopping guided by dashed arrows as shown in FIG. 8A. In this case, two simultaneous single-DCI based multi-TRP repetition processes without frequency hopping are shown in FIG. 8A guided by solid arrows.

Similarly, repetition without frequency/panel switching may also be achieved by two simultaneous single-TRP repetition processes without frequency hopping as shown in FIG. 8B guided by dashed arrows. In addition, two simultaneous single-DCI based multi-TRP repetition processes with frequency hopping are shown in FIG. 8B guided by solid arrows.

SDM STxMP Transmission with TD Repetition

In SDM STxMP transmission, the same frequency resources may be allocated for the UL transmission through panel 1 and panel 2. In SDM STxMP TD repetitions, the association of the two panels with the PUSCH may be switched or may not be switched in each next STxMP transmission occasion, and the scheduling may be single-DCI or multi-DCI, as illustrated by the following embodiments.

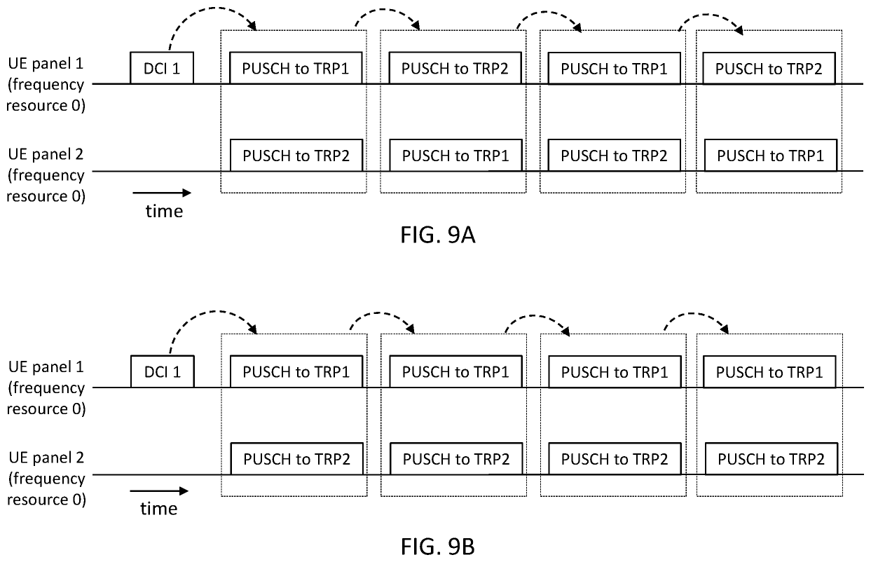

FIGS. 9A and 9B respectively illustrate single-DCI based SDM STxMP with TD repetition with or without frequency/panel switching in accordance with some embodiments. That is, the SDM STxMP with TD repetition may be scheduled by a single DCI with or without frequency/panel switching. The single DCI at least indicates the number of TD repetitions. In particular, time domain resource allocation field may be used to indicate the one row from a table for the time domain resource allocation of the PUSCH transmission, which includes number of repetitions, mapping type, and SLIV.

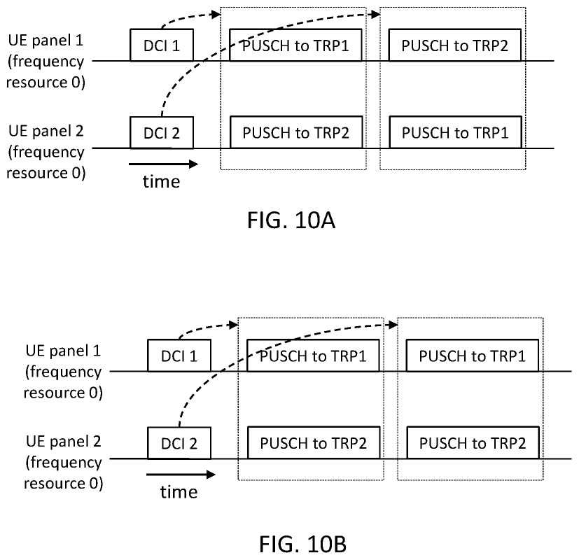

FIGS. 10A and 10B respectively illustrate multi-DCI based SDM STxMP with TD repetition with or without frequency/panel switching in accordance with some embodiments. That is, multiple DCIs are used in FIGS. 10A and 10B, rather than the single DCI shown in FIGS. 9A and 9B.

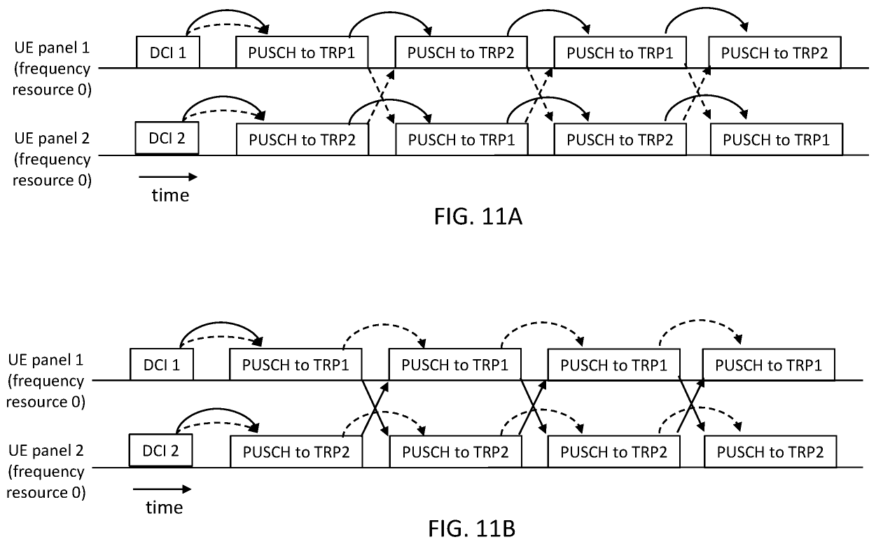

In another embodiment, multi-DCI based SDM STxMP with TD repetition with or without frequency/panel switching may be achieved by other methods. FIGS. 11A and 11B respectively illustrate multi-DCI based SDM STxMP with TD repetition with or without frequency/panel switching in accordance with some embodiments.

In particular, repetition with frequency/panel switching may also be achieved by two simultaneous single-TRP repetition processes with panel switching guided by dashed arrows as shown in FIG. 11A. In this case, two simultaneous single-DCI based multi-TRP repetition processes without panel switching are shown in FIG. 11A guided by solid arrows.

Similarly, repetition without panel switching may also be achieved by two simultaneous single-TRP repetition processes without panel switching as shown in FIG. 11B guided by dashed arrows. In addition, two simultaneous single-DCI based multi-TRP repetition processes with panel switching are shown in FIG. 11B guided by solid arrows.

In another embodiment, when time domain repetition is applied for the STxMP transmission, beam cycling may be applied for the PUSCH from different panels. The existing beam cycling pattern with cyclic and sequential beam mapping may be used for the PUSCH transmission in each panel, which may further improve the reliability.

In one option, four SRS resource sets may be configured for STxMP PUSCH transmission with beam cycling in each panel, where the first two SRS resource sets may be associated with the PUSCH transmission for a first panel and the second two SRS resource sets may be associated with the PUSCH transmission for a second panel. Further, the SRS resource set indication may be extended to indicate whether beam cycling is enabled or disabled for STxMP transmission.

In another option, two SRS resource sets may be configured for the STxMP PUSCH transmission with beam cycling, where each panel is associated with both SRS resource sets. In this case, panel 1 and panel 2 may be associated with different SRS resource sets for each STxMP transmission.

### A/SP-CSI Multiplexing on STxMP

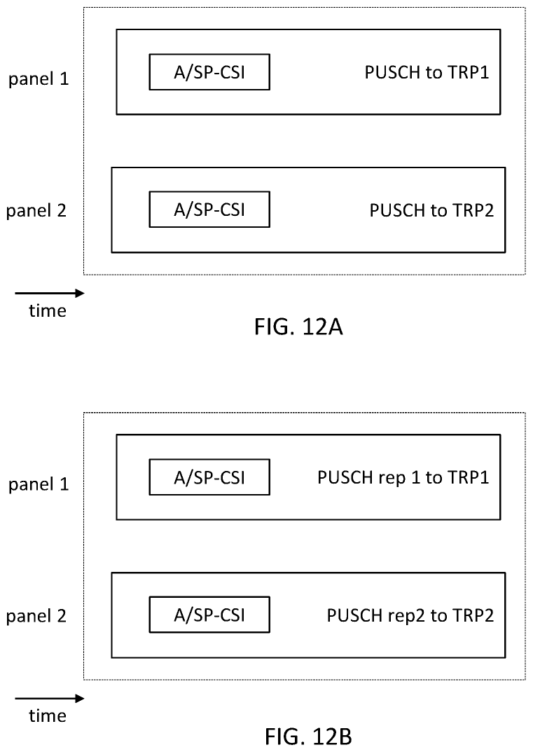

When aperiodic-CSI (A-CSI) or semi-persistent CSI (SP-CSI) is scheduled together with STxMP PUSCH transmission, the A/SP-CSI may be multiplexed on the STxMP PUSCH transmission. FIGS. 12A and 12B respectively illustrate an aperiodic-channel state information (A-CSI) or semi-persistent CSI (SP-CSI) multiplexing on a STxMP PUSCH transmission or STxMP PUSCH repetitions in accordance with some embodiments. As shown in FIG. 12A, the A/SP-CSI may be multiplexed on the STxMP PUSCH transmission through both panels.

Note that when other uplink control information (UCI) types including Hybrid Automatic Repeat Request acknowledgement (HARQ-ACK) feedback is multiplexed with the A/SP-CSI on the PUSCH only for one of the panels, an A/SP-CSI report is only multiplexed on the PUSCH for one of the panels. For instance, if HARQ-ACK feedback is multiplexed with the A/SP-CSI on the PUSCH for panel 1, the A/SP-CSI report is only multiplexed on the PUSCH for panel 1.

Further, for a SDM scheme, a FDM scheme A, an SFN-based transmission scheme, when the A/SP-CSI is multiplexed on the STxMP PUSCH transmission for both panels, the number of resources allocated for the A/SP-CSI transmission is determined in accordance with the total resource allocated for PUSCH transmission for both panels.

For an FDM scheme B and a SDM repetition scheme, when the A/SP-CSI is multiplexed on the STxMP PUSCH transmission for both panels, the number of resources allocated for the A/SP-CSI transmission is determined in accordance with the resource allocated for the PUSCH transmission for each panel, respectively.

Note that the above embodiments may also apply when time domain repetition is applied for the STxMP PUSCH.

In another embodiment, the A/SP-CSI may be multiplexed on the STxMP PUSCH transmission through both panels if the PUSCH transmission from both panels are repetitions, which may have the same RV or different RVs, of the same TB, as shown in FIG. 12B.

A/SP-CSI Multiplexing on STxMP with TD Repetition

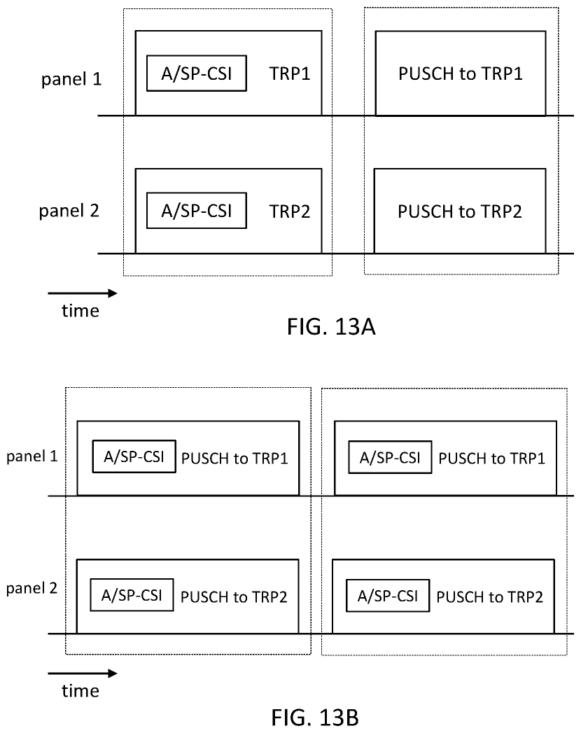

FIGS. 13A and 13B respectively illustrate an A-CSI or SP-CSI multiplexing on a first TD repetition or on first and second repetitions of a STxMP PUSCH transmission in accordance with some embodiments. Thus, as shown in FIG. 13A, the A/SP-CSI is only multiplexed on the first TD repetition of the STxMP PUSCH transmission. Similarly, the A/SP-CSI may be multiplexed on the first TD repetition and the second TD repetition of the STxMP PUSCH transmission as shown in FIG. 13B.

Note that when the A/SP-CSI on the STxMP PUSCH transmission with TD repetition without a transport block, the number of repetitions for the A/SP-CSI is only 1 for the PUSCH transmission in each panel. This may apply for the case for the activation of the SP-CSI transmission on the PUSCH or the SP-CSI on the PUSCH without a corresponding PDCCH.

Further, for PUSCH repetition type B, the UE may expect the same number of symbols for nominal and actual repetition. If the number of symbols for nominal and actual repetitions for each panel is different, the UE may drop the A-CSI and/or SP-CSI report.

### Mechanisms on PUCCH Resource Configuration for STxMP Operation

Multiple STxMP transmission schemes may be considered for PUCCH transmission, i.e., FDM, single frequency network (SFN). For instance, as above the following schemes may be used: FDM-A scheme: different frequency domain parts of one PUCCH resource are transmitted by two different UE panels. FDM-B scheme: two FDMed PUCCH transmission occasions of the same UCI with the same PUCCH format are transmitted from two different UE panels SFN scheme: the same PUCCH/PUCCH-DMRS is transmitted from two different UE panels simultaneously.

Further, STxMP PUCCH transmission may be scheduled by either a single DCI (sDCI) or multiple DCIs (mDCI). When the STxMP PUCCH transmission is scheduled by a sDCI, PUCCH resources on more than one panel are determined. Further, for an FDM-A scheme, when PUCCH format 3 is used for carrying the UCI payload, certain mechanisms may be defined on the transmission scheme so as to reduce the Peak-to-Average Power Ratio (PAPR).

Mechanisms are described herein on PUCCH resource configuration for STxMP operation. In particular, a PUCCH resource configuration for STxMP operation, frequency resource partitioning for a STxMP FDM-A scheme, a STxMP FDM-A scheme for PUCCH format 3 and a PUSCH with a Discrete Fourier transform-spread orthogonal frequency-division multiplexing (DFT-s-OFDM) waveform, and a STxMP CDM scheme for PUCCH format 0/1/4 are described. In some aspects, a panel ID may be explicitly indicated or configured for a panel for STxMP transmission, or implicitly linked to another ID, e.g., a control resource set (CORESET) ID, TRP ID, etc.

### PUCCH Resource Configuration for STxMP Operation

As above, multiple STxMP transmission schemes may be considered for PUCCH transmission, i.e., FDM, SFN. STxMP PUCCH transmission may be scheduled by either a sDCI or multiple DCIs. When the STxMP PUCCH transmission is scheduled by sDCI, PUCCH resources on more than one panel are determined.

Embodiments of PUCCH resource configuration for STxMP operation are provided as follows:

In some aspects, the following embodiments may apply for all PUCCH formats including PUCCH format 0, 1, 2, 3 and 4.

In one embodiment, for a sDCI STxMP PUCCH transmission scheme, a PUCCH resource indicator (PRI) may be included in the DCI format 1_1 and/or 1_2 for scheduling a PDSCH, where the PRI and/or starting positioning of a control channel element (CCE) for the corresponding physical downlink control channel (PDCCH) transmission may be used to determine a PUCCH resource. Further, more than one transmission occasion or frequency resources from a first and second panel may be included in the PUCCH resource.

In one option, the following PUCCH-Resource information element (IE) may be updated to include a second starting PRB index in the first and second hop as indicated below. In some aspects, the starting PRB index in the first and second hop in the existing PUCCH resource IE may be used for the STxMP PUCCH transmission from the first panel; where the second starting PRB index in the first and second hop may be used for the STxMP PUCCH transmission from the second panel. In some aspects, when frequency hopping is disabled, the second starting PRB index for the second hop is not applicable.

| | |
|---|---|
| PUCCH-Resource ::= | SEQUENCE { |
| pucch-ResourceId | PUCCH-ResourceId, |
| startingPRB | PRB-Id, |
| startingPRB2 | PRB-Id, |
| intraSlotFrequencyHopping | ENUMERATED { enabled } |
| OPTIONAL, -- Need R | |
| secondHopPRB | PRB-Id |
| OPTIONAL, -- Need R | |
| secondHopPRB2 | PRB-Id |
| OPTIONAL, -- Need R | |
| format | CHOICE { |
| format0 | PUCCH-format0, |
| format1 | PUCCH-format1, |
| format2 | PUCCH-format2, |
| format3 | PUCCH-format3, |
| format4 | PUCCH-format4 |
| } | |
| } | |

In some aspects, a second starting PRB index in the first and second hop may not be present in the PUCCH resource IE. This may indicate the SFN operation for a STxMP PUCCH transmission. Alternatively, a second starting PRB index in the first and second hop may be equal to the starting PRB index in the first and second hop in the PUCCH resource IE. This may also indicate the SFN operation for a STxMP PUCCH transmission.

In another option, the following PUCCH-Resource IE may be updated to include a PRB distance between the PUCCH transmission from a first and second panel as indicated below. In some aspects, when frequency hopping is enabled for a PUCCH transmission, the same PRB distance is applied for the PUCCH transmission for the second hop between the PUCCH transmission from a first and second panel.

| | |
|---|---|
| PUCCH-Resource ::= | SEQUENCE { |
| pucch-ResourceId | PUCCH-ResourceId, |
| startingPRB | PRB-Id, |
| distancePRB | PRB-Id, |
| intraSlotFrequencyHopping | ENUMERATED { enabled } |
| OPTIONAL, -- Need R | |
| secondHopPRB | PRB-Id |
| OPTIONAL, -- Need R | |
| format | CHOICE { |
| format0 | PUCCH-format0, |
| format1 | PUCCH-format1, |
| format2 | PUCCH-format2, |
| format3 | PUCCH-format3, |
| format4 | PUCCH-format4 |
| } | |
| } | |

In some aspects, when a PRB distance is not present in the PUCCH resource IE, this may indicate the SFN operation for a STxMP PUCCH transmission.

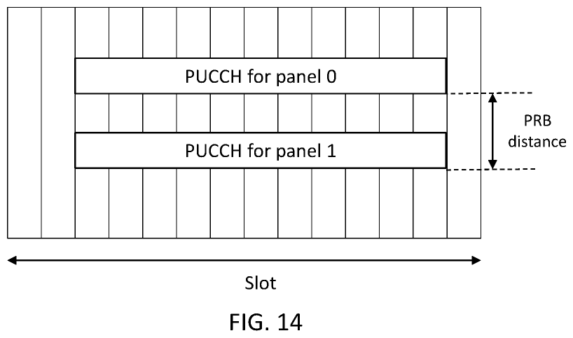

FIG. 14 illustrates PRB distance for a PUCCH transmission from a first and second panel transmission in accordance with some embodiments. In the example shown in FIG. 14, a PRB distance is configured between the PUCCH transmission from a first and second panel.

In another embodiment, a Medium Access Control-Control Element (MAC-CE) for PUCCH spatial relation Activation/Deactivation for multiple TRP PUCCH repetition may be extended to support STxMP PUCCH transmission. In particular, a panel ID may be included in a PUCCH spatial relation Activation/Deactivation for multiple TRP PUCCH repetition MAC CE. In some aspects, bit “0” may indicate a first panel while bit “1” may indicate a second panel.

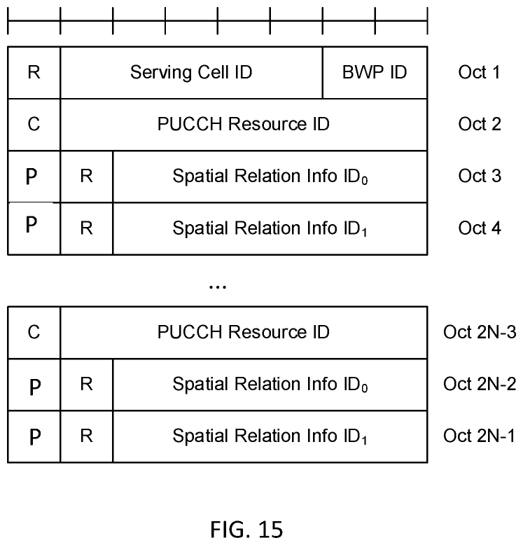

FIG. 15 illustrates a panel ID in accordance with some embodiments. The Panel ID of FIG. 15 is in a PUCCH spatial relation Activation/Deactivation MAC-CE. In FIG. 15, the first reserved bit in the Oct for each spatial relation info ID is updated for panel ID. In some aspects, bit “0” may indicate a first panel while bit “1” may indicate a second panel.

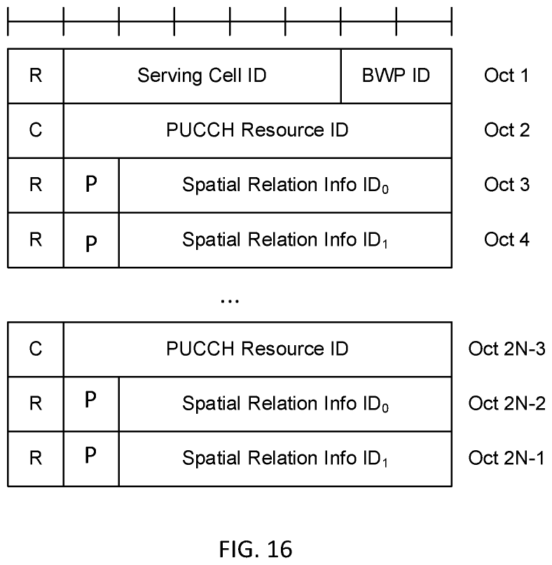

FIG. 16 illustrates another panel ID in accordance with some embodiments. Like FIG. 15, the Panel ID of FIG. 16 is in a PUCCH spatial relation Activation/Deactivation MAC-CE. In the FIG. 16, the second reserved bit in the Oct for each spatial relation info ID is updated for panel ID. In some aspects, bit “0” may indicate a first panel while bit “1” may indicate a second panel.

In another option, a new MAC-CE may be defined to the PUCCH spatial relation Activation and Deactivation for STxMP PUCCH transmission. In the MAC CE, one or more following parameters may be included: serving cell ID, BWP ID, panel ID, PUCCH resource ID, a first associated spatial relation info ID for a first panel and a second associated spatial relation info ID for a second panel.

In another embodiment, a PUCCH Power Control Set Update for multiple TRP PUCCH repetition MAC-CE may be extend to support STxMP PUCCH transmission. In particular, the panel ID may be included in the PUCCH Power Control Set Update for multiple TRP PUCCH repetition MAC-CE. In some aspects, bit “0” may indicate a first panel while bit “1” may indicate a second panel.

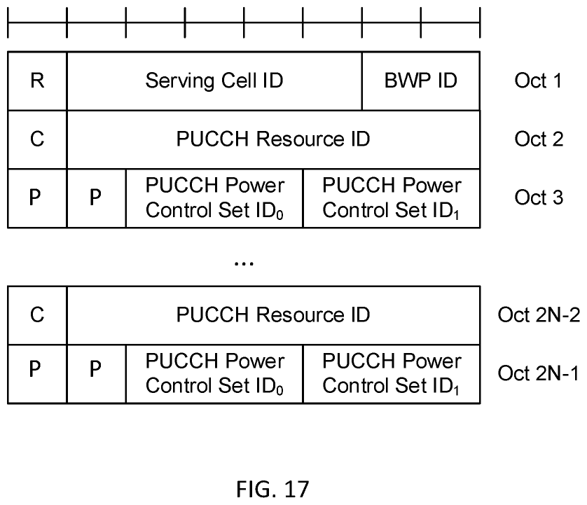

FIG. 17 illustrates another panel ID in accordance with some embodiments. The Panel ID of FIG. 17 is in a PUCCH Power Control Set Update MAC-CE for STxMP PUCCH operation. In FIG. 17, the first and second reserved bits in the Oct for PUCCH power control set IDs are updated for panel ID. In some aspects, bit “0” may indicate a first panel while bit “1” may indicate a second panel.

In another option, a new MAC-CE may be defined to a PUCCH Power Control Set Update for STxMP PUCCH transmission. In the MAC CE, one or more following parameters may be included: serving cell ID, BWP ID, panel ID, PUCCH resource ID, a first associated PUCCH power control set ID for a first panel and a second associated PUCCH power control set ID for a second panel.

In another embodiment, for a sDCI STxMP PUCCH transmission scheme, a first and second PRI may be included in the DCI format 1_1 and/or 1_2 for scheduling a PDSCH, where the first and second PRI and/or starting positioning of a CCE for the corresponding PDCCH transmission may be used to determine a first and second PUCCH resource from a first and second panel, respectively.

In another option, a first PRI is included in the DCI format 1_1 and/or 1_2 for scheduling a PDSCH. Further, a differentiated PRI may be also included in the same DCI, where the second PRI may be determined based on the first PRI and the differentiated PRI.

In some aspects, panel information including panel identity may be configured as part of PUCCH resource configuration. In one example, the following PUCCH-Resource IE may be updated to include the panel ID as indicated.

| | |
|---|---|
| PUCCH-Resource ::= | SEQUENCE |
| pucch-ResourceId | PUCCH-ResourceId, |
| pucch-PanelID | pucch-PanelID |
| startingPRB | PRB-Id, |
| intraSlotFrequencyHopping | ENUMERATED { enabled } |
| OPTIONAL, -- Need R | |
| secondHopPRB | PRB-Id |
| OPTIONAL, -- Need R | |
| format | CHOICE { |
| format0 | PUCCH-format0, |
| format1 | PUCCH-format1, |
| format2 | PUCCH-format2, |
| format3 | PUCCH-format3, |
| format4 | PUCCH-format4 |
| } | |
| } | |

In another example, the following PUCCH-SpatialRelationInfo IE may be updated to include the panel ID as indicated.

| | |
|---|---|
| PUCCH-SpatialRelationInfo ::= | SEQUENCE { |
| pucch-SpatialRelationInfoId | PUCCH-SpatialRelationInfoId, |
| servingCellId | ServCellIndex |
| OPTIONAL, -- Need S | |
| pucch-PanelID | pucch-PanelID |
| referenceSignal | CHOICE { |
| ssb-Index | SSB-Index, |
| csi-RS-Index | NZP-CSI-RS-ResourceId, |
| srs | PUCCH-SRS |
| }, | |
| pucch-PathlossReferenceRS-Id | PUCCH-PathlossReferenceRS-Id, |
| p0-PUCCH-Id | P0-PUCCH-Id, |
| closedLoopIndex | ENUMERATED { i0, i1 } |
| } | |

For this option, the UE may expect that same PUCCH format, starting symbols and number of symbols, and number of PRB are used for STxMP PUCCH transmissions.

In another embodiment, for a sDCI STxMP PUCCH transmission scheme, a PRI may be included in the DCI format 1_1 and/or 1_2 for scheduling PDSCH, where a PRI and/or starting positioning of CCE for the corresponding PDCCH transmission may be used to determine a set of PUCCH resources. In particular, the group of PUCCH resources include a first and second PUCCH resource from a first and second panel, respectively.

For this option, a panel ID may be included as part of PUCCH resource configuration or PUCCH spatial relation info configuration.

### Frequency Resource Partitioning for STxMP FDM-A Scheme

Embodiments of frequency resource partitioning for STxMP FDM-A scheme are provided as follows:

In some aspects, a STxMP FDM-A PUCCH transmission scheme may apply for PUCCH format 2 and/or 3.

In one embodiment, for an FDM-A STxMP PUCCH scheme, a frequency resource for the PUCCH transmission for a first and second panel may be contiguous. Further, assuming the number of PRBs configured for a PUCCH format 2 is N_{PRB}, the PUCCH transmission for the first panel and second panel occupies └N_{PRB}/2┘ and └N_{PRB}/2┘, respectively.

In some aspects, when frequency hopping is enabled, this may also apply for the frequency resource in the second hop for the PUCCH transmission for the first and second panel.

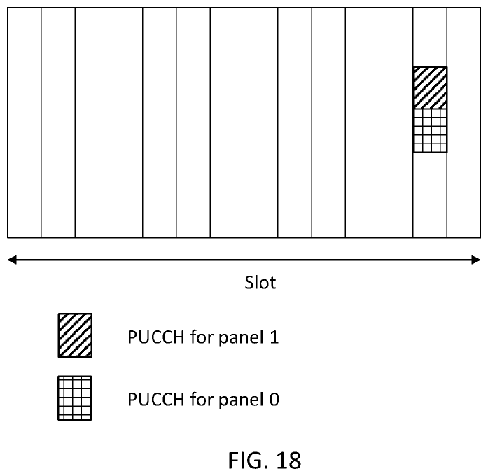

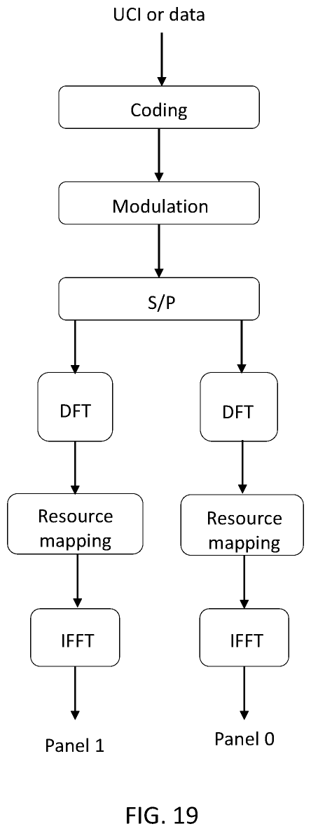

FIG. 18 illustrates a frequency resource for PUCCH for a first and second panel for STxMP operation in accordance with some embodiments. In FIG. 18, it is assumed 10 PRBs are allocated for the PUCCH format 2. In this case, the first 5 PRBs are allocated for PUCCH transmission for the first panel, while the second 5 PRBs are allocated for PUCCH transmission for the second panel.

In another embodiment, for an FDM-A STxMP PUCCH scheme, a frequency resource for the PUCCH transmission for a first and second panel may be interleaved. In particular, the frequency resource for the PUCCH transmission for the first panel may be allocated with every even K PRBs, while the frequency resource for the PUCCH transmission for the second panel may be allocated with every odd K PRBs, or vice versa.

In some aspects, K may be pre-defined in the specification or configured by higher layers (higher layer signaling) via NR RMSI, NR OSI or dedicated RRC signaling, dynamically indicated in the DCI, or a combination thereof. In another option, K may be determined in accordance with the number of PRBs configured for a PUCCH resource. In one example, K=1 or 2.

STxMP FDM-A Scheme for PUCCH Format 3 and PUSCH with DFT-s-OFDM Waveform

Embodiments of a STxMP FDM-A scheme for PUCCH format 3 and a PUSCH with DFT-s-OFDM waveform are provided as follows:

In one embodiment, for a STxMP FDM-A scheme for PUCCH format 3 and a PUSCH with DFT-s-OFDM waveform, modulated symbols for the PUCCH and PUSCH transmission with a DFT-s-OFDM waveform may be equally split into two parts, where the first and second part are input to a first and second DFT, respectively. Further, the modulated symbols after the DFT operation are mapped to the allocated resources for the PUCCH and PUSCH transmission for the first and second panel, respectively.

FIG. 19 illustrates separate DFT operations for modulated symbols for a STxMP PUCCH FDM-A scheme in accordance with some embodiments. In FIG. 19, a first and second DFT is applied for the split modulated symbols for the PUCCH transmission for a first and second panel, respectively.

In another embodiment, for a STxMP FDM-A scheme for PUCCH format 3 and a PUSCH with DFT-s-OFDM waveform, a single DFT is applied for the modulated symbol for PUCCH and PUSCH transmission. Further, the modulated symbols after DFT operation are equally split into two parts, where the first and second part are mapped to the allocated resources for the PUCCH and PUSCH transmission for the first and second panel, respectively.

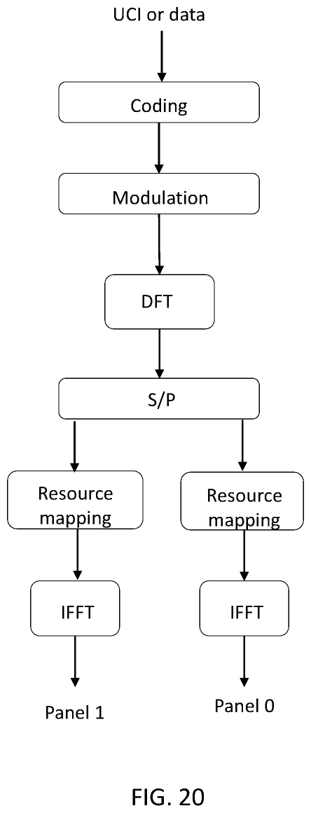

FIG. 20 illustrates a single DFT operation for modulated symbols for a STxMP PUCCH FDM-A scheme in accordance with some embodiments. In FIG. 20, a single DFT is applied for the modulated symbol for PUCCH and PUSCH transmission.

### STxMP CDM Scheme for PUCCH Format 0/1/4

Embodiments of STxMP CDM scheme for PUCCH format 0/1/4 are provided as follows:

In one embodiment, for PUCCH format 0 and 1, different cyclic shifts may be configured for the STxMP PUCCH transmission from a first and second panel, respectively. In some aspects, the initial cyclic shift in the existing PUCCH format 0 and format 1 IE may be used for the STxMP PUCCH transmission from the first panel; where the second initial cyclic shift may be used for the STxMP PUCCH transmission from the second panel.

In one option, the following PUCCH-format0 and PUCCH-format1 IE may be updated to include a second initial cyclic shift as indicated below, respectively.

| | |
|---|---|
| PUCCH-format0 ::= | SEQUENCE { |
| initialCyclicShift | INTEGER(0..11), |
| initialCyclicShift2 | INTEGER(0..11), |
| nrofSymbols | INTEGER (1..2), |
| startingSymbolIndex | INTEGER(0..13) |
| } | |
| PUCCH-format1 ::= | SEQUENCE { |
| initialCyclicShift | INTEGER(0..11), |
| initialCyclicShift2 | INTEGER(0..11), |
| nrofSymbols | INTEGER (4..14), |
| startingSymbolIndex | INTEGER(0..10), |
| timeDomainOCC | INTEGER(0..6) |
| } | |

In another embodiment, for PUCCH format 4, a different orthogonal cover code (OCC) index may be configured for the STxMP PUCCH transmission from a first and second panel, respectively. In some aspects, the OCC index in the existing PUCCH format 4 IE may be used for the STxMP PUCCH transmission from the first panel; where the second OCC index may be used for the STxMP PUCCH transmission from the second panel.

In one option, the following PUCCH-format4 may be updated to include a second OCC index as indicated below.

| | |
|---|---|
| PUCCH-format4 ::= | SEQUENCE { |
| nrofSymbols | INTEGER (4..14), |
| occ-Length | ENUMERATED {n2,n4}, |
| occ-Index | ENUMERATED {n0,n1,n2,n3}, |
| occ-Index2 | ENUMERATED {n0,n1,n2,n3}, |
| startingSymbolIndex | INTEGER(0..10) |
| } | |

### Precoding Indication and Maximum Rank Configuration for STxMP

As above, multiple antennas may be equipped in each panel of the UE and TRP. Therefore, the UE may perform precoding of the data and control information to be transmitted to achieve higher data rate and reliability. The precoding matrix for UL transmission may either be pre-defined as a codebook or computed by the UE. In other words, two transmission modes, namely, codebook (CB) based transmission and non-codebook (nCB) based transmission are supported. For CB based transmission, the gNB provides the UE with a transmit precoding matrix indication in the DCI. The UE uses the indicator, which is called transmitted precoding matrix indicator (TPMI), to select the PUSCH transmit precoder from a set of codebooks. For nCB based transmission, the UE determines its PUSCH precoder based on a CSI-RS measurement from the downlink, and determines the number of layers of the transmission based on an SRS resource indication (SRI) field from the DCI.

In summary, for CB based transmission, the UE determines its PUSCH transmission precoder(s) based on based on the SRI(s), TPMI(s), and the transmission rank. For nCB based transmission, the UE may determine its PUSCH precoder(s) and transmission rank based on the SRI(s) when multiple SRS resources are configured. Note that the SRI is a DCI field, and TPMI(s) and the transmission rank are given by DCI fields called Precoding information and number of layers (PINL).

However, the above precoding indication methodology is applicable to single-TRP based PUSCH transmission and multi-TRP based PUSCH repetition (two PUSCH repetitions are transmitted in different time domain resources). In simultaneous multi-TRP multi-panel PUSCH transmission, there may be more PUSCH transmission schemes and more conditions/constraints under different transmission schemes.

Furthermore, in Rel-17 multi-TRP PUSCH transmission, the maxRank configured by RRC signaling is applied to both PUSCH repetitions. However, in SDMed STxMP PUSCH transmission, the two PUSCH transmitted from two panels may have different ranks. Thus, how to configure the maximum ranks for the two panels is to be considered.

Several methods are indicated herein to enhance the precoding indication, i.e., the SRI field and PINL field, for simultaneous multi-TRP multi-panel PUSCH (SxPUSCH) transmission, and methods of configuring the maximum ranks. Note that SxPUSCH is the same as STxMP PUSCH.

### Maximum Rank Indication for Single-DCI Based STxMP Transmission

In one embodiment, two maximum ranks, e.g., maxRank and maxRank2, may be configured for panel-1 and panel-2 respectively.

In another embodiment, the legacy configuration, e.g., maxRank, may be reused for the total maximum rank across two panels. For example, if maxRank=3, layer combinations 1+1, 1+2, 2+1 may be transmitted.

In another embodiment, if two maximum ranks are configured, the maximum ranks may be mapped to different UE capability value sets.

### DCI Field(s) Determination for Single-DCI Based STxMP PUSCH

In one embodiment, for nCB-based STxMP PUSCH transmissions and CB-based STxMP PUSCH transmissions with different numbers of ports in the configured SRS resources, two SRI fields may be used to indicate the two SRS resources from the two SRS resource sets corresponding to the two TRPs separately. But for CB-based STxMP PUSCH transmissions with the same number of ports in the configured SRS resources, only one SRI field may be used in the DCI.

In another embodiment, for nCB-based STxMP PUSCH transmissions and CB-based STxMP PUSCH transmissions with different numbers of ports in the configured SRS resources, two SRI fields may be used to indicate the two SRS resources from the two SRS resource sets corresponding to the two TRPs separately. But for CB-based STxMP PUSCH transmissions with the same number of ports in the configured SRS resources, no SRI field is indicated in the DCI.

In another embodiment, for both CB-based and nCB-based PUSCH transmissions, two DCI fields of SRI are indicated.

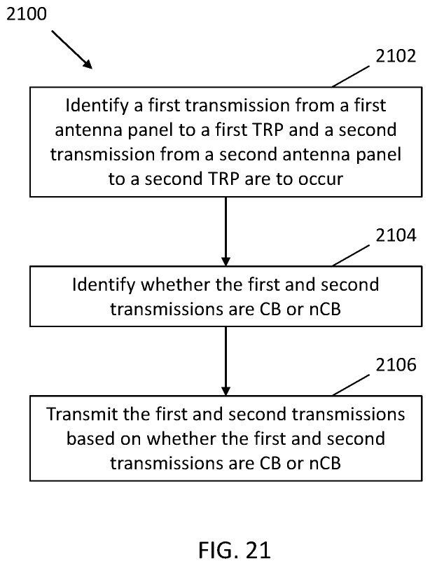

In some embodiments, the electronic devices, networks, systems, chips or components, or portions or implementations thereof, of the above figures may be configured to perform one or more processes, techniques, or methods as described herein, or portions thereof. One such process is depicted in FIG. 21, which illustrates a flowchart of CB and nCB based multi-TRP transmissions in accordance with some embodiments. Specifically, the process 2100 of FIG. 21 may include or relate to a method to be performed by a UE, one or more elements of a UE, and/or an electronic device that includes or implements a UE. The process 2100 may include identifying, at operation 2102, that a first transmission from a first antenna panel to a first TRP and a second transmission from a second antenna panel to a second TRP are to occur; identifying, at operation 2104, whether the first and second transmissions are CB or nCB; and transmitting, at operation 2106, the first and second transmissions based on whether the first and second transmissions are CB or nCB.

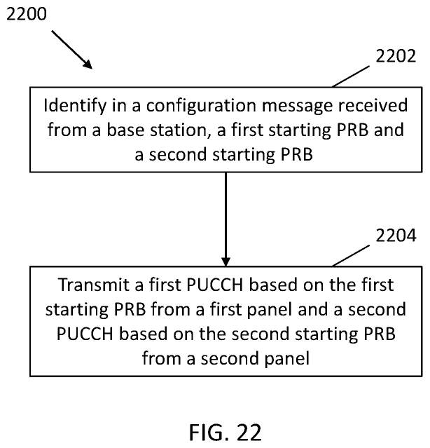

FIG. 22 illustrates a flowchart of PUCCH transmission in accordance with some embodiments. The process 2200 of FIG. 22 may include or relate to a method to be performed by a UE, one or more elements of a UE, and/or one or more electronic devices that include or implement an element of a UE. The process 2200 may include identifying, at operation 2202 in a configuration message received from a base station, a first starting PRB and a second starting PRB; and transmitting, at operation 2204, a first PUCCH based on the first starting PRB from a first panel and a second PUCCH based on the second starting PRB from a second panel.

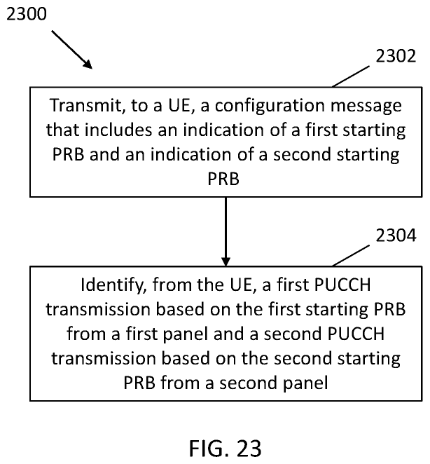

FIG. 23 illustrates another flowchart of PUCCH transmission in accordance with some embodiments. The process 2300 of FIG. 23 may include or relate to a method to be performed by a base station, one or more elements of a base station, and/or one or more electronic devices that include or implement an element of a base station. The process 2300 of FIG. 23 may include transmitting, at operation 2302 to a UE, a configuration message that includes an indication of a first starting PRB and an indication of a second starting PRB; and identifying, at operation 2304 from the UE, a first PUCCH transmission based on the first starting PRB from a first panel and a second PUCCH transmission based on the second starting PRB from a second panel.

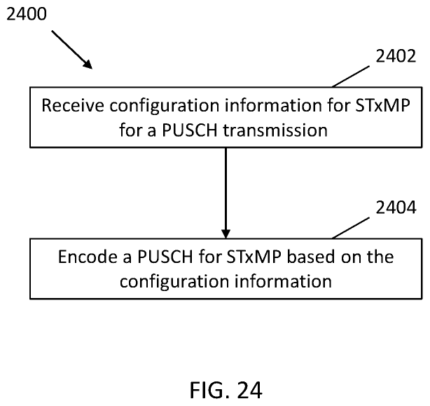

FIG. 24 illustrates a flowchart of PUSCH transmission in accordance with some embodiments. The process 2400 of FIG. 24 may include or relate to a method to be performed by a base station, one or more elements of a base station, and/or one or more electronic devices that include or implement an element of a base station. The process 2400 of FIG. 24 include, at operation 2402, receiving configuration information for STxMP for a PUSCH transmission. The process further includes, at operation 2404, encoding a PUSCH for STxMP based on the configuration information.

### Examples

Example 1 is an apparatus for a user equipment (UE), the apparatus comprising: memory; and processing circuitry, to configure the UE to: receive at least one downlink control information (DCI) to schedule simultaneous transmission with multi-panel (STxMP) uplink (UL) transmission; determine, from the at least one DCI, whether time domain (TD) repetition is to be applied to the UL; and transmit the UL transmission to multiple transmit-receive points (TRPs) based on a determination whether TD repetition is to be applied; and wherein the memory is configured to store the DCI.

In Example 2, the subject matter of Example 1 includes, wherein the processing circuitry is further configured to use type-A slot-based repetition for the UL transmission.

In Example 3, the subject matter of Examples 1-2 includes, wherein the processing circuitry is further configured to use type-B back-to-back repetition for the UL transmission.

In Example 4, the subject matter of Examples 1-3 includes, wherein the processing circuitry is further configured to use multi-panel transmission for the UL transmission, the UL transmission using identical frequency resources for spatial domain multiplexing (SDM) and different frequency resources for frequency domain multiplexing (FDM).

In Example 5, the subject matter of Examples 1-4 includes, wherein: the UL transmission is a Physical Uplink Shared Channel (PUSCH) transmission, and the processing circuitry is further configured to, in a first mode, associate a PUSCH transmission in a first panel with a first sounding reference signal (SRS) resource set and a PUSCH transmission in a second panel with a second SRS resource set, and, in a second mode, associate the PUSCH transmission in the first panel with the second SRS resource set and the PUSCH transmission in the second panel with the first SRS resource set.

In Example 6, the subject matter of Example 5 includes, wherein the processing circuitry is further configured to switch between the first mode and the second mode based on an SRS resource set indication in downlink control information (DCI).

In Example 7, the subject matter of Examples 1-6 includes, wherein the processing circuitry is further configured to determine whether panel switching is enabled during the TD repetition based on a downlink control information (DCI) field.

In Example 8, the subject matter of Examples 1-7 includes, wherein the processing circuitry is further configured to determine for each panel a redundancy version (RV) for a STxMP Physical Uplink Shared Channel (PUSCH) with and without TD repetition based on a single DCI, the RV for each panel dependent on whether each panel is configured to transmit an identical transmission block (TB) or different TBs, the single DCI including a number of TD repetitions.

In Example 9, the subject matter of Example 8 includes, wherein the processing circuitry is further configured to determine, based on an RV offset value in the single DCI, an RV offset for each panel dependent on whether each panel is configured to transmit the identical TB or different TBs.

In Example 10, the subject matter of Examples 1-9 includes, wherein the processing circuitry is further configured to use frequency domain multiplexing (FDM) for the STxMP UL transmission, consecutive physical resource blocks (PRBs) in an UL bandwidth part (BWP) being allocated for the UL transmission by different panels.

In Example 11, the subject matter of Example 10 includes, wherein the processing circuitry is further configured to determine a frequency resource allocation for the UL transmission of one of the panels from a frequency domain resource allocation (FDRA) field in the at least one DCI for scheduling the UL transmission.

In Example 12, the subject matter of Example 11 includes, wherein the processing circuitry is further configured to determine a frequency offset between a starting PRB of the UL transmission in the panels from at least one of: higher layer signaling via at least one of remaining minimum system information (RMSI), other system information (OSI), or dedicated radio resource control (RRC) signaling, or a dynamic indication in the at least one DCI.

In Example 13, the subject matter of Examples 11-12 includes, wherein the processing circuitry is further configured to determine a frequency offset between a starting PRB of the UL transmission in the panels based on a frequency offset configured for intra-slot, inter-repetition, or inter-slot frequency hopping of the UL transmission.

In Example 14, the subject matter of Examples 1-13 includes, wherein the processing circuitry is further configured to use frequency domain multiplexing (FDM) for the STxMP UL transmission, interleaved physical resource blocks (PRBs) in an UL bandwidth part (BWP) being allocated for the UL transmission by different panels.

In Example 15, the subject matter of Example 14 includes, wherein the processing circuitry is further configured to determine a number of PRBs of each panel from at least one of: higher layer signaling via at least one of remaining minimum system information (RMSI), other system information (OSI), or dedicated radio resource control (RRC) signaling, a dynamic indication in a single DCI, or a Resource Block Group (RBG) size when uplink resource allocation type 0 is used for frequency resource allocation.

In Example 16, the subject matter of Examples 14-15 includes, wherein the processing circuitry is further configured to determine a frequency resource for each panel from a frequency domain resource allocation (FDRA) field in a single DCI when uplink resource allocation type 0 or 1 is used for frequency resource allocation.

In Example 17, the subject matter of Examples 1-16 includes, wherein the processing circuitry is further configured to determine, from a time domain resource allocation (TDRA) field in a single DCI, a number of TD repetitions, mapping type, and starting and length indicator value (SLIV) for TDRA.

In Example 18, the subject matter of Examples 1-17 includes, wherein the processing circuitry is further configured to determine, from multiple DCIs, frequency domain multiplexing (FDM) STxMP UL transmission with TD repetition with or without at least one of frequency or panel switching.

In Example 19, the subject matter of Example 18 includes, wherein the processing circuitry is further configured to determine, for TD repetition with the at least one of frequency or panel switching, two simultaneous single-TRP repetition processes with frequency hopping or two simultaneous single-DCI based multi-TRP repetition processes without frequency hopping.

In Example 20, the subject matter of Examples 18-19 includes, wherein the processing circuitry is further configured to determine, for TD repetition without the at least one of frequency or panel switching, two simultaneous single-TRP repetition processes without frequency hopping or two simultaneous single-DCI based multi-TRP repetition processes with frequency hopping.

In Example 21, the subject matter of Examples 1-20 includes, wherein the processing circuitry is further configured to: use spatial domain multiplexing (SDM) STxMP UL transmission with TD repetition using identical frequency resources allocated for each panel, and determine whether to switch association of the panels in each STxMP transmission occasion.

In Example 22, the subject matter of Example 21 includes, wherein the processing circuitry is further configured to determine, from a time domain resource allocation (TDRA) field in a single DCI, a number of TD repetitions, mapping type, and starting and length indicator value (SLIV) for TDRA of the SDM STxMP UL transmission with TD repetition.

In Example 23, the subject matter of Examples 21-22 includes, wherein the processing circuitry is further configured to determine from multiple DCIs: TD repetition with panel switching using two simultaneous single-TRP repetition processes with panel switching or two simultaneous single-DCI based multi-TRP repetition processes without panel switching, or TD repetition without panel switching using two simultaneous single-TRP repetition processes without panel switching or two simultaneous single-DCI based multi-TRP repetition processes with panel switching.

In Example 24, the subject matter of Examples 1-23 includes, wherein the processing circuitry is further configured to: use spatial domain multiplexing (SDM) STxMP UL transmission with TD repetition with beam cycling, and one of: use two different sounding reference signal (SRS) resource sets for the STxMP UL transmission with beam cycling for each panel, an SRS resource set indication configured to indicate whether beam cycling is enabled for the STxMP UL transmission, or use identical two SRS resource sets for the STxMP UL transmission with beam cycling for each panel, each STxMP UL transmission for each panel is associated with different SRS resource sets.

In Example 25, the subject matter of Examples 1-24 includes, wherein: the processing circuitry is further configured to multiplex an aperiodic-channel state information (A-CSI) or semi-persistent CSI (SP-CSI) transmission with the STxMP UL transmission through multiple panels, for a spatial domain multiplexing (SDM) scheme, frequency domain multiplexing (FDM) scheme A, or a single frequency network (SFN)-based transmission scheme, a number of resources allocated for the A-CSI or SP-CSI transmission is determined in accordance with a total resource allocated for the STxMP UL transmission for both panels, and for an FDM scheme B and a SDM repetition scheme, a number of resources allocated for the A-CSI or SP-CSI transmission is determined in accordance with resource allocation for the STxMP UL transmission for each panel, respectively.

In Example 26, the subject matter of Examples 1-25 includes, wherein the processing circuitry is further configured to multiplex an aperiodic-channel state information (A-CSI) or semi-persistent CSI (SP-CSI) transmission with only a first TD repetition of the STxMP UL transmission or with the first and a second repetition of the STxMP UL transmission.

In Example 27, the subject matter of Examples 1-26 includes, wherein the processing circuitry is further configured to determine, from a single DCI, an independent maximum rank for each panel.

In Example 28, the subject matter of Example 27 includes, wherein the maximum ranks are mapped to different UE capability value sets.

In Example 29, the subject matter of Examples 1-28 includes, wherein the processing circuitry is further configured to separately determine, from sounding reference signal (SRS) resource indication (SRI) fields in the at least one DCI, SRS resources from SRS resource sets corresponding to the TRPs for non-codebook (nCB)-based STxMP UL transmissions and CB-based STxMP UL transmissions with different numbers of ports in the SRS resources.

In Example 30, the subject matter of Examples 1-29 includes, wherein the processing circuitry is further configured to determine, from a single sounding reference signal (SRS) resource indication (SRI) field in the at least one DCI, SRS resources from SRS resource sets corresponding to the TRPs for codebook (nCB)-based STxMP UL transmissions with identical numbers of ports in the SRS resources.

In Example 31, the subject matter of Examples 1-30 includes, wherein the processing circuitry is further configured to determine SRS resources from SRS resource sets corresponding to the TRPs for codebook (nCB)-based STxMP UL transmissions with identical numbers of ports in the SRS resources without use of a sounding reference signal (SRS) resource indication (SRI) field in the at least one DCI.

In Example 32, the subject matter of Examples 1-31 includes, wherein the processing circuitry is further configured to determine, from separate sounding reference signal (SRS) resource indication (SRI) fields in the at least one DCI, SRS resources from SRS resource sets corresponding to the TRPs for non-codebook (nCB)-based STxMP UL transmissions and CB-based STxMP UL transmissions independent of a number of ports in the SRS resources.

In Example 33, the subject matter of Examples 1-32 includes, wherein the processing circuitry is further configured to: receive, from a 5th generation NodeB, a first and second starting physical resource block (PRB) for a physical uplink control channel (PUCCH) resource; and transmit a multi-panel (STxMP) PUCCH transmission from a first panel using the first starting PRB simultaneously with a PUCCH from a second panel using the second starting PRB.

In Example 34, the subject matter of Example 33 includes, wherein the processing circuitry is further configured to use more than one transmission occasion or frequency resource from the first and second panel in the PUCCH resource.

In Example 35, the subject matter of Examples 33-34 includes, wherein the processing circuitry is further configured to use a first starting PRB index in a first and second hop in a PUCCH resource information element (IE) for the STxMP PUCCH transmission from the first panel and a second starting PRB index in the first and second hop for the STxMP PUCCH transmission from the second panel.

In Example 36, the subject matter of Examples 33-35 includes, wherein the processing circuitry is further configured to determine, from the PUCCH resource, a PRB distance between the STxMP PUCCH transmission from the first and second panel.

In Example 37, the subject matter of Examples 33-36 includes, wherein the processing circuitry is further configured to determine a panel identifier (ID) from at least one of: a PUCCH spatial relation Activation/Deactivation or PUCCH Power Control Set Update for multiple TRP PUCCH repetition Medium Access Control-Control Element (MAC-CE), a PUCCH resource configuration, or PUCCH spatial relation information.

In Example 38, the subject matter of Examples 33-37 includes, wherein: a first and second PUCCH resource indicator (PRI) in a DCI format 1_1 or 1_2 for scheduling a physical downlink shared channel (PDSCH) in a single DCI STxMP PUCCH transmission scheme, and the processing circuitry is further configured to use at least one of the first and second PRI or a starting positioning of a control channel element (CCE) for a corresponding PDCCH transmission to respectively determine a first and second PUCCH resource from the first and second panel.

In Example 39, the subject matter of Examples 33-38 includes, wherein the processing circuitry is further configured to use contiguous frequency resources for the STxMP PUCCH transmission for the first and second panel for a frequency domain multiplexing (FDM)-A STxMP PUCCH scheme.

In Example 40, the subject matter of Examples 33-39 includes, wherein the processing circuitry is further configured to use interleaved frequency resources for the STxMP PUCCH transmission for the first and second panel for a frequency domain multiplexing (FDM)-A STxMP PUCCH scheme.

In Example 41, the subject matter of Examples 33-40 includes, wherein the processing circuitry is further configured to equally split, for STxMP frequency domain multiplexing (FDM)-A scheme for PUCCH format 3 and physical uplink shared channel (PUSCH) with a Discrete Fourier transform-spread orthogonal frequency-division multiplexing (DFT-s-OFDM) waveform, modulated symbols for PUCCH and PUSCH transmission, each portion of the modulated symbols provided to a different DFT.

In Example 42, the subject matter of Examples 33-41 includes, wherein the processing circuitry is further configured to use, for STxMP FDM-A scheme for PUCCH format 3 and physical uplink shared channel (PUSCH) with a Discrete Fourier transform-spread orthogonal frequency-division multiplexing (DFT-s-OFDM) waveform, a single DFT for modulated symbols for PUCCH and PUSCH transmission.

In Example 43, the subject matter of Examples 33-42 includes, wherein the processing circuitry is further configured to use, for PUCCH format 0 and 1, different cyclic shifts for the STxMP PUCCH transmission from the first and second panel.

In Example 44, the subject matter of Examples 33-43 includes, wherein the processing circuitry is further configured to use, for PUCCH format 4, a different orthogonal cover code (OCC) index for the STxMP PUCCH transmission from the first and second panel.

Example 45 is at least one machine-readable medium including instructions that, when executed by processing circuitry, cause the processing circuitry to perform operations to implement of any of Examples 1-44.

Example 46 is an apparatus comprising means to implement of any of Examples 1-44.

Example 47 is a system to implement of any of Examples 1-44.

Example 48 is a method to implement of any of Examples 1-44.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1-20. (canceled)

21. An apparatus for a user equipment (UE), the apparatus comprising:
processing circuitry configured to:
decode, from a fifth generation NodeB (gNB), at least one downlink control information (DCI) to schedule simultaneous transmission over multi-panel (STxMP) uplink (UL) transmission;
determine, from the at least one DCI, whether time domain (TD) repetition is to be applied to the STxMP UL transmission; and
encode the STxMP UL transmission for transmission to multiple transmit-receive points (TRPs) based on a determination whether TD repetition is to be applied; and
memory configured to store the DCI.

22. The apparatus of claim 21, wherein the processing circuitry is further configured to use multi-panel transmission for the STxMP UL transmission, the STxMP UL transmission using identical frequency resources for spatial domain multiplexing (SDM) and different frequency resources for frequency domain multiplexing (FDM).

23. The apparatus of claim 21, wherein:
the STxMP UL transmission is a Physical Uplink Shared Channel (PUSCH) transmission, and
the processing circuitry is further configured to:
in a first mode, associate a PUSCH transmission in a first panel with a first sounding reference signal (SRS) resource set and a PUSCH transmission in a second panel with a second SRS resource set,
in a second mode, associate the PUSCH transmission in the first panel with the second SRS resource set and the PUSCH transmission in the second panel with the first SRS resource set, and
switch between the first mode and the second mode based on an SRS resource set indication in downlink control information (DCI).

24. The apparatus of claim 21, wherein the processing circuitry is further configured to determine whether panel switching is enabled during the TD repetition based on a downlink control information (DCI) field.

25. The apparatus of claim 21, wherein the processing circuitry is further configured to determine:
for each panel a redundancy version (RV) for a STxMP Physical Uplink Shared Channel (PUSCH) with and without TD repetition based on a single DCI, the RV for each panel dependent on whether each panel is configured to transmit an identical transmission block (TB) or different TBs, the single DCI indicating a number of TD repetitions, and
based on an RV offset value in the single DCI, an RV offset for each panel dependent on whether each panel is configured to transmit the identical TB or different TBs.

26. The apparatus of claim 21, wherein the processing circuitry is further configured to:
use frequency domain multiplexing (FDM) for the STxMP UL transmission, consecutive physical resource blocks (PRBs) in an UL bandwidth part (BWP) being allocated for the STxMP UL transmission by different panels,
determine a frequency resource allocation for the STxMP UL transmission of one of the panels from a frequency domain resource allocation (FDRA) field in the at least one DCI for scheduling the STxMP UL transmission,
determine a frequency offset between a starting PRB of the STxMP UL transmission in the panels from at least one of:
higher layer signaling via at least one of remaining minimum system information (RMSI), other system information (OSI), or dedicated radio resource control (RRC) signaling, or
a dynamic indication in the at least one DCI, and
determine a frequency offset between a starting PRB of the STxMP UL transmission in the panels based on a frequency offset configured for intra-slot, inter-repetition, or inter-slot frequency hopping of the STxMP UL transmission.

27. The apparatus of claim 21, wherein the processing circuitry is further configured to:
use frequency domain multiplexing (FDM) for the STxMP UL transmission, interleaved physical resource blocks (PRBs) in an UL bandwidth part (BWP) being allocated for the STxMP UL transmission by different panels, and
at least one of:
determine a number of PRBs of each panel from at least one of:
higher layer signaling via at least one of remaining minimum system information (RMSI), other system information (OSI), or dedicated radio resource control (RRC) signaling,
a dynamic indication in a single DCI, or
a Resource Block Group (RBG) size when uplink resource allocation type 0 is used for frequency resource allocation, or
determine a frequency resource for each panel from a frequency domain resource allocation (FDRA) field in a single DCI when uplink resource allocation type 0 or 1 is used for frequency resource allocation.

28. The apparatus of claim 21, wherein the processing circuitry is further configured to determine:
from multiple DCIs, frequency domain multiplexing (FDM) STxMP UL transmission with TD repetition with or without at least one of frequency or panel switching, and
at least one of:
for TD repetition with the at least one of frequency or panel switching, two simultaneous single-TRP repetition processes with frequency hopping or two single-DCI based simultaneous multi-TRP repetition processes without frequency hopping, or
for TD repetition without the at least one of frequency or panel switching, two simultaneous single-TRP repetition processes without frequency hopping or two single-DCI based simultaneous multi-TRP repetition processes with frequency hopping.

29. The apparatus of claim 21, wherein the processing circuitry is further configured to:
use spatial domain multiplexing (SDM) STxMP UL transmission with TD repetition using identical frequency resources allocated for each panel of multiple panels, and
determine whether to switch association of the panels in each STxMP transmission occasion, and
at least one of:
determine, from a time domain resource allocation (TDRA) field in a single DCI, a number of TD repetitions, mapping type, and starting and length indicator value (SLIV) for TDRA of the SDM STxMP UL transmission with TD repetition, or
determine from multiple DCIs:
TD repetition with panel switching using two simultaneous single-TRP repetition processes with panel switching or two single-DCI based simultaneous multi-TRP repetition processes without panel switching, or
TD repetition without panel switching using two simultaneous single-TRP repetition processes without panel switching or two single-DCI based simultaneous multi-TRP repetition processes with panel switching.

30. The apparatus of claim 21, wherein the processing circuitry is further configured to:
use spatial domain multiplexing (SDM) STxMP UL transmission with TD repetition with beam cycling, and one of:
use two different sounding reference signal (SRS) resource sets for the STxMP UL transmission with beam cycling for each panel, an SRS resource set indication configured to indicate whether beam cycling is enabled for the STxMP UL transmission, or
use identical two SRS resource sets for the STxMP UL transmission with beam cycling for each panel, each UL transmission for each panel is associated with different SRS resource sets.

31. The apparatus of claim 21, wherein:
the processing circuitry is further configured to multiplex an aperiodic-channel state information (A-CSI) or semi-persistent CSI (SP-CSI) transmission with the STxMP UL transmission through multiple panels,
for a spatial domain multiplexing (SDM) scheme, frequency domain multiplexing (FDM) scheme A, or a single frequency network (SFN)-based transmission scheme, a number of resources allocated for the A-CSI or SP-CSI transmission is determined in accordance with a total resource allocated for the STxMP UL transmission for both panels, and
for an FDM scheme B and a SDM repetition scheme, a number of resources allocated for the A-CSI or SP-CSI transmission is determined in accordance with resource allocation for the STxMP UL transmission for each panel, respectively.

32. The apparatus of claim 21, wherein the processing circuitry is further configured to multiplex an aperiodic-channel state information (A-CSI) or semi-persistent CSI (SP-CSI) transmission with only a first TD repetition of the STxMP UL transmission or with the first TD repetition of the STxMP UL transmission and a second TD repetition of the STxMP UL transmission.

33. The apparatus of claim 21, wherein:
the processing circuitry is further configured to determine, from a single DCI, an independent maximum rank for each panel, and
the maximum ranks are mapped to different UE capability value sets.

34. The apparatus of claim 21, wherein the processing circuitry is further configured to at least one of:
separately determine, from sounding reference signal (SRS) resource indication (SRI) fields in the at least one DCI, SRS resources from SRS resource sets corresponding to the TRPs for non-codebook (nCB)-based STxMP UL transmissions and CB-based STxMP UL transmissions with different numbers of ports in the SRS resources, or
determine:
from a single SRI field in the at least one DCI, SRS resources from SRS resource sets corresponding to the TRPs for CB-based STxMP UL transmissions with identical numbers of ports in the SRS resources, or
SRS resources from SRS resource sets corresponding to the TRPs for CB-based STxMP UL transmissions with identical numbers of ports in the SRS resources without use of any SRI field in the at least one DCI.

35. The apparatus of claim 21, wherein the processing circuitry is further configured to:
decode, from the gNB, a first starting physical resource block (PRB) and a second starting PRB for a physical uplink control channel (PUCCH) resource; and
encode a simultaneous transmission over multi-panel (STxMP) PUCCH transmissions for transmission from a first panel using the first starting PRB simultaneously with a PUCCH from a second panel using the second starting PRB.

36. The apparatus of claim 35, wherein the processing circuitry is further configured to use at least one of:
more than one transmission occasion or frequency resource from the first panel and the second panel in the PUCCH resource, or
a first starting PRB index in a first and second hop in a PUCCH resource information element (IE) for the STxMP PUCCH transmission from the first panel and a second starting PRB index in the first and second hop for the STxMP PUCCH transmission from the second panel.

37. An apparatus for a fifth generation NodeB (gNB), the apparatus comprising:
processing circuitry, to configure the gNB to:
encode, for transmission to a user equipment (UE), at least one downlink control information (DCI) to schedule simultaneous transmission over multi-panel (STxMP) uplink (UL) transmission, the at least one DCI configured to indicate whether time domain (TD) repetition is to be applied to the STxMP UL transmission; and
decode, from the UE, the STxMP UL transmission directed to multiple transmit-receive points (TRPs) based on a determination whether TD repetition is to be applied; and
memory configured to store the DCI.

38. The apparatus of claim 37, wherein the processing circuitry is further configured to:
encode, for transmission to the UE, a first starting physical resource block (PRB) and a second starting PRB for a physical uplink control channel (PUCCH) resource; and
decode a multi-panel (STxMP) PUCCH transmission from at least one of a first panel of the UE using the first starting PRB simultaneously with a PUCCH from a second panel of the UE using the second starting PRB.

39. A non-transitory computer-readable storage medium that stores instructions for execution by one or more processors of a user equipment (UE), the one or more processors to configure the UE to, when the instructions are executed:
decode, from a fifth generation NodeB (gNB), at least one downlink control information (DCI) to schedule simultaneous transmission over multi-panel (STxMP) uplink (UL) transmission;
determine, from the at least one DCI, whether time domain (TD) repetition is to be applied to the STxMP UL transmission; and
encode the UL transmission for transmission to multiple transmit-receive points (TRPs) based on a determination whether TD repetition is to be applied.

40. The non-transitory computer-readable storage medium of claim 39, wherein the instructions, when executed, further configure the one or more processors to cause the UE to use multi-panel transmission for the STxMP UL transmission, the STxMP UL transmission using identical frequency resources for spatial domain multiplexing (SDM) and different frequency resources for frequency domain multiplexing (FDM).
